(19) United States
(12) Patent Application Publication
(10) Pub. No.: US 2026/0233810 A1
(43) Pub. Date: Aug. 13, 2026

(54) SHIP TO SHORE HORIZONTAL CONTAINER TRANSFER SYSTEMS

(71) Applicant: Tsvi Bar, Tel Aviv (IL)

(72) Inventor: Tsvi Bar, Tel Aviv (IL)

(21) Appl. No.: 19/470,835

(22) PCT Filed: May 1, 2024
(86) PCT No.: PCT/IL2024/050409

§ 371 Date: Sep. 30, 2025

Related U.S. Application Data
(60) Provisional application No. 63/463,196, filed on May 1, 2023.

(51) Int. Cl. B63B 27/10; B63B 25/00; B66C 19/00

(52) U.S. Cl. CPC B63B 27/10; B63B 25/004; B66C 19/00

(57) ABSTRACT

There is provided herein a container vessel crane for horizontal and vertical relocation of cargo containers on a cargo vessel, the container vessel crane includes a trolly including: a container chamber which includes at least a bottom opening configured to insert the container into the container chamber; a spreader and head block chamber, mounted on top of the container chamber; and a machine room mounted on the spreader and head block chamber; a spreader, and a headblock comprising one or more pulleys and one or more cables; four or more container casting connections atop the machine room configured to facilitate connection by the spreader of the ship-to-shore (STS) crane; one or more cable drums configured to rotate thus to roll or unroll the one or more cables thereby allowing vertical movement (up and down) of the container; and one or more engines coupled to the one or more cable drums.

### RELATED APPLICATION/S

This application is a Continuation in Part of International patent application PCT/IL2024/050409 filed on 1 May 2024 which claims the benefit of priority under 35 USC § 119(e) of U.S. Provisional Patent Application No. 63/463,196 filed on 1 May 2023, the contents of which are incorporated herein by reference in their entirety

### TECHNICAL FIELD

The present disclosure relates to mega horizontal ship to shore (STS) container transfer systems and methods of use thereof.

### BACKGROUND

Cargo vessels cross the oceans carrying merchandise are responsible for about 90% of world trade. As international trade rises sharply, port congestion is becoming a major issue as waiting time for cargo vessels outside the ports is growing rapidly. Therefore, time saving action is essential to reduce port congestion and to allow the global supply chain to flow freely.

Cargo containers are commonly used at sea aboard cargo vessels and the land by freight trains or trucks across countries as well. Containers have standard international sizes, shapes and other requirements, since they are repeatedly loaded on different vessels and other forms of transport and must be suitable for any type of international carrier.

Currently, cargo vessels are loaded by ship to shore cranes (STS) at ports, where each cargo container is handled individually, requiring multiple assorted cranes and vehicles working together.

Therefore, there is a need for a system and method to reduce port congestion by more efficiently transferring cargo containers from ship to shore and vice versa.

### SUMMARY

According to some embodiments there is provided herein a system and method for efficiently transferring cargo containers from ship to shore and vice versa and within the ship.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

There is provided herein, according to some embodiments, a container vessel crane for horizontal and vertical relocation of cargo containers on a cargo vessel, the container vessel crane including:
a trolly including:
   a container chamber configured to accommodate a container to be relocated, the container chamber includes at least a bottom opening configured to insert the container into the container chamber;
   a spreader and head block chamber, mounted on top of the container chamber; and
   a machine room mounted on the spreader and head block chamber;
a spreader positioned within the spreader and head block chamber and configured to connect/disconnect to/from the container;
a headblock including one or more pulleys and one or more cables, the headblock is positioned on top of the spreader and within the spreader and head block chamber;
four or more container casting connections atop the machine room configured to facilitate connection by the spreader of the ship-to-shore (STS) crane;
one or more cable drums positioned within the machine room configured to rotate thus to roll or unroll the one or more cables thereby allowing vertical movement (up and down) of the container; and
one or more engines coupled to the one or more cable drums.

According to some embodiments, the four or more container casting connections atop the machine room, are identical to casting connections atop 20 Ft (TEU) container and/or atop 40 Ft (FEU) container, thereby allowing ship to shore (STS) crane to connect to the container vessel crane and hoist it on target bay onboard the cargo vessel. According to some embodiments, the four or more container casting connections atop the machine room are welded.

Advantageously, in accordance with some embodiments, the herein disclosed vessel crane can connect to STS cranes in the same way that a cargo container does (using the casting connections), thus allowing seamless loading and unloading operations, optimizing the use of the STS cranes, and facilitating smooth cargo handling processes at ports or terminals. This further enhances productivity, reduces the vessel's turnaround times, and improves operational efficiency in maritime logistics.

According to some embodiments, the term “bay” may refer to specific sections or compartments on a vessel's cargo deck where cargo containers are arranged or stored during transportation.

According to some embodiments, the trolly may further include a set of side wheels connected to bottom side bases of the trolly and configured to facilitate transvers and horizontal movement of the trolly on board of the cargo vessel.

According to some embodiments, the one or more engines includes gears.

According to some embodiments, the container vessel crane may be configured for movement over modified lashing bridges equipped with rails positioned atop them, wherein the modified lashing bridges are heightened above a highest (upper) tier of cargo containers.

According to some embodiments, the side wheels may have a V-shaped cross-section to allow centralized movement of the side wheels within the rails. According to some embodiments, the side wheels may have other cross sections shapes.

According to some embodiments, the rails may have a V-shaped cross-section with a negative shape configured to compatibly accommodate the set of side wheels. According to some embodiments, the rails may have other cross sections shapes.

According to some embodiments, the side wheels may be contractable when passing through the STS legs and extractable after passing STS legs and before mounting on top of the rails, thus allowing easer pass of the container vessel crane between the legs of the STS crane, thereby facilitating shorter trolley's structure (about 45 feet) of the container vessel crane.

According to some embodiments, the container vessel crane may be configured to facilitate extracting/relocating cargo containers located at lower tiers aboard of the cargo vessel and/or at the lower tiers within the underdeck of the cargo vessel.

According to some embodiments, the container vessel crane may further include a controller unit for manual/autonomous operation or wireless communication with a user.

According to some embodiments, the container chamber may be configured to secure the cargo container.

According to some embodiments, the container chamber may be configured to position the cargo container at a lifted position so as to move over upper tier (of on-board cargo containers).

According to some embodiments, the set of side wheels may be powered by two sided separate sets of engines and gears to facilitate reliable operation.

According to some embodiments, the one or more engines may be electric, hydraulic, pneumatic engines, or a combination thereof. Each possibility is a separate embodiment.

According to some embodiments, the container chamber and the spreader and head block chamber may be joint as one chamber.

According to some embodiments, the container vessel may be mountable on the cargo vessel while moored (docked) at a terminal and/or while at sea (during a voyage).

According to some embodiments, the term “terminal” may refer to facilities located at ports where cargo handling, storage, and transfer activities take place. According to some embodiments, the term “terminal” may refer to a pier or a dock.

According to some embodiments, the container chamber may be configured to accommodate one or more cargo containers.

According to some embodiments, the rails of the modified lashing bridges include horizontally extendable beams with rails on their top allowing the container vessel crane to exit the cargo vessel perimeters thereby enabling unloading and/or loading containers directly to/from a shore, a truck, or a train.

According to some embodiments, the container vessel crane may further include extendable diagonal reinforcements configured to support the rails when horizontally extended.

There is provided herein, according to some embodiments, a modified lashing bridge for facilitating a container vessel crane movement thereatop, the modified lashing bridge includes:
a rail positioned atop the lashing bridge; and
a stopper (bumper) mounted at the end of the rail and configured to limit the container vessel crane's movement beyond the rail,
wherein the modified lashing bridge is configured to be installed on top of the existing lashing bridge of a cargo vessel thereby heightening the lashing bridge above the highest tier of cargo containers.
wherein the lashing bridges include a fixed diagonal reinforcement at a base thereof configured to enhance strength and longitudinal tilt resistance of the modified lashing bridges.

According to some embodiments, the modified lashing bridges may further include horizontally extendable beams with rails on top thereof allowing the container vessel crane to exit the cargo vessel perimeters thereby enabling unloading (or loading) containers to (or from) a shore, a truck, or a train.

According to some embodiments, the modified lashing bridges may further include extendable diagonal ratchet telescopic hydraulic reinforcements configured to support the extended rails when horizontally extended.

There is provided herein, according to some embodiments, a system for horizontal and vertical relocation of cargo container on a cargo vessel, the system includes:
a container vessel crane, the container vessel crane including:
   a trolly including: a container chamber configured to accommodate a container to be relocated; spreader and head block chamber, mounted on top of the container chamber; and machine room mounted on the spreader and head block chamber; and
   a spreader positioned within the spreader and head block chamber and configured to connect/disconnect to/from the container, and
   a headblock including one or more pulleys and one or more cables, the headblock is positioned on top of the spreader and within the spreader and head block chamber;
   one or more cable drums positioned within the machine room configured to rotate thus to roll or unroll the one or more cables thereby allowing vertical movement (up and down) of the container; and
   one or more engines coupled to the one or more cable drums; and
at least two modified lashing bridges for facilitating the container vessel crane transverse and horizontal movement thereatop, the modified lashing bridges include: a rail positioned atop each of the at least two lashing bridges; and a stopper (bumper) mounted at the end of each of the rails and configured to limit the container vessel crane's movement beyond the rails, wherein the at least two modified lashing bridges are configured to be installed on top of the existing lashing bridges of the cargo vessel thereby heightening the lashing bridges above the highest tier of cargo containers.

There is provided herein, according to some embodiments, a method for relocating a cargo container on a cargo vessel from distal side of the cargo vessel to proximal side of cargo vessel or vice versa, using a container vessel crane and modified lashing bridges, wherein the distal side of the cargo vessel is the side of the vessel farthest from the terminal and the proximal side of the cargo vessel is the side of the vessel closest to the terminal and containers, the method includes: loading a container vessel crane onto rails atop modified lashing bridges of a cargo vessel, the container vessel crane includes: a trolly comprising a container chamber; a spreader connectable to a cargo container; a headblock comprising: one or more pulleys and one or more cables; one or more cable drums; and one or more engines coupled to the one or more cable drums, lowering the spreader and connecting it to a cargo container located at a distal side of the cargo vessel; lifting the cargo container, using the one or more cables, to insert the cargo container into the container chamber; relocating the trolly (thereby the cargo container) transversely and horizontally over the rails; and unloading the container by lowering the spreader with the cargo container, using the one or more cables, and disconnecting the cargo container from the spreader at a desired location at a proximal side of the cargo vessel.

There is provided herein, according to some embodiments, a method for relocating a cargo container on a cargo vessel from distal side of the cargo vessel directly to a shore, a truck, or a train or vice versa, using a container vessel crane and modified lashing bridges, wherein the distal side of the cargo vessel is the side of the vessel farthest from the terminal and the proximal side of the cargo vessel is the side of the vessel closest to the terminal and containers, the method includes: loading a container vessel crane onto extendable beams with rails atop modified lashing bridges of a cargo vessel, the container vessel crane includes: a trolly comprising a container chamber; a spreader connectable to a cargo container; a headblock including: one or more pulleys and one or more cables; one or more cable drums; and one or more engines coupled to the one or more cable drums, lowering the spreader and connecting it to a cargo container located at a distal side of the cargo vessel; lifting the cargo container, using the one or more cables, to insert the cargo container into the container chamber; horizontally extending the extendable beams with rails atop the modified lashing bridges, such that extendable beams with rails exit the perimeter of the cargo vessel; relocating the trolly (thereby the cargo container) transversely and horizontally over the extensions of the extendable beams with rails so as to relocate the cargo container outside the cargo vessel perimeters; and unloading the container by lowering (vertically) the spreader with the cargo container, using the one or more cables, and disconnecting the cargo container from the spreader to a shore, a truck, or a train.

According to some embodiments, the method may further include simultaneously operating multiple (preferably two) container vessel cranes each on a separate bay to assist each ship to shore (STS) cranes by relocating cargo containers close to the terminal thus reducing the ship to shore crane route and by relocating cargo containers from distal rows with respect to the terminal to proximal rows with respect to the terminal.

According to some embodiments, the term “row” may refer to a row of cargo containers, for example, linear arrangements of cargo containers along the length of a vessel's cargo deck or within the terminal storage area/yard.

Advantageously, according to some embodiments, the herein disclosed vessel crane, is configured to relocate cargo containers from the distal side of the cargo vessel to the proximal side of the cargo vessel, thereby effectively assisting STS cranes by reducing their routes. Shortening the route of the STS cranes enhances operational efficiency and minimizes maintenance requirements. Furthermore, there is a reduction in energy consumption, which leads to cost savings and environmental benefits. Additionally, decreased travel distance contributes to faster cycle times for loading and unloading operations, thereby improving overall terminal productivity. Advantageously, as disclosed herein, multiple container vessel cranes can simultaneously assist the ship-to-shore (STS) crane, thereby substantially reducing the loading and unloading costs.

According to some embodiments, the method may further include mounting modified lashing bridges atop on-board lashing bridges (at the sides of a bay) of a cargo vessel, the modified lashing bridges include: a rail positioned atop the lashing bridge, and a stopper (bumper) mounted at the end of the rail.

There is provided herein, according to some embodiments, a use of the container vessel crane for relocating cargo container at the terminal's yard on designated rails on ground.

There is provided herein, according to some embodiments, a mega ship to shore (STS) cargo horizontal container transfer system, the system includes:
a plurality of vehicles, such as but not limited to, mega train, mega carrier and mega crane configured to move horizontally batches of cargo containers from terminal's yard to the cargo vessel and vice versa.

According to some embodiments, the mega crane is configured for moving alongside the cargo vessel on a specific rail, and for lifting batches of containers up to target tiers, the mega crane includes:
a high hollow cubical structure including: a set of hoist engines attached to cable drums mounted over the structure at the machine section; a set of pad conveyors (preferable 3) attached by cables to the cable drums each enables to lift and convey a batch of containers; and a set of bogie wheels to allow parallel movement to the cargo vessel;
one or more cable drums positioned within the machine section configured to rotate thus to roll or unroll the one or more cables thereby allowing vertical movement (up and down) of the pad conveyors;
a pad conveyor equipped with winch engines at his front and rear sides configured to pull batches of containers over the pad itself; and
one or more engines coupled to the one or more cable drums.

According to some embodiments, the high hollow cubical structure may further include: a set of bogie wheels connected to a bottom side base of the trolly and configured to facilitate parallel movement to the cargo vessel; a travel tray configured to transform between two configurations, an extended configuration, and a retracted configuration, to facilitate horizontal movement over travel motorized wheels; a flat rectangular structure sized as 40 Ft container with 4 funnel immersed spots located in its corners that configured to absorb cargo container with semi auto twist locks same as under 40 Ft (FEU) standard cargo containers or 8 spots as described herein to allow 2 of 20 Ft (TEU) to be placed on; and a leading edge at the sides of the travel tray meant to facilitate the horizontal movement over the travel motorized wheels located on every carrier mentioned.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

In the figures:

FIG. 1: An overview schematic diagram of an exemplary port movement order of a mega STS carriers and cranes systems in accordance with some embodiments of the present invention;

FIG. 2: Schematic diagrams of various views of a travel tray, in accordance with some embodiments of the present invention;

FIGS. 3A-C: Schematic diagrams of a travel tray and travel wheels, in accordance with some embodiments;

FIG. 4: A schematic diagram of a rear view of a container loaded onto a mega train, in accordance with some embodiments;

FIG. 5: A schematic diagram of a side view of a mega train, in accordance with some embodiments;

FIG. 6: A schematic diagram of transfer of containers from a mega train to a mega carrier, in accordance with some embodiments;

FIG. 7: Schematic diagrams of a top view of a mega carrier, in accordance with some embodiments;

FIG. 8: Schematic diagrams of a mega carrier stopped at a mega crane alongside a cargo vessel for loading and unloading, according to some embodiments;

FIGS. 9A-B: Schematic diagrams of side views of a mega crane before loading containers onto a cargo vessel and after complete downloading, respectively, in accordance with some embodiments;

FIGS. 10A-B: Schematic diagrams of a front view and top views, respectively, of a mega crane with reinforcing legs, in accordance with some embodiments;

FIGS. 11A-D: Schematic diagrams of top, side, front, and back views, respectively, of a mega crane, in accordance with some embodiments;

FIGS. 12A-B: Schematic diagrams of a cargo vessel and mega crane adjustment, in accordance with some embodiments of the present invention;

FIGS. 13A-B: Schematic diagrams of a cargo vessel and mega crane cargo transfer, in accordance with some embodiments of the present invention;

FIGS. 14A-B: Schematic diagrams of a side view of a hydraulic system, in accordance with some embodiments;

FIGS. 15A-B: Schematic diagrams of a side view of a hydraulic system, in accordance with some embodiments;

FIG. 16: Schematic diagram of a top view of containers on a cargo vessel, in accordance with some embodiments;

FIG. 17: Schematic diagram of a side view with hydraulic pistons before raising the containers on a cargo vessel, in accordance with some embodiments;

FIG. 18: Schematic diagram of a side view with hydraulic pistons after raising the containers on a cargo vessel, in accordance with some embodiments;

FIG. 19: Schematic diagram of a side view of a cargo vessel with winch system, in accordance with some embodiments;

FIG. 20: Schematic diagram of a cargo vessel with a vessel crane, in accordance with some embodiments;

FIGS. 21A-E: Schematic diagrams of some views of a vessel crane, in accordance with some embodiments;

FIG. 21F: Schematically shows a front view of a container vessel crane, according to some embodiments;

FIG. 21G: Schematically shows a top view of the container vessel crane of FIG. 21F, according to some embodiments;

FIG. 21H: Schematically shows a side view of cargo vessel with modified (heightened) lashing bridges, according to some embodiments;

FIG. 21I: Schematically shows a cargo vessel with horizontally extended rails and modified lashing bridges, according to some embodiments;

FIG. 21J: Schematically shows a top view of the cargo vessel of FIG. 21H, and a division of cargo extraction areas between the STS crane and the container vessel crane, according to some embodiments;

FIG. 21K: Schematically shows a top view of the cargo vessel of FIG. 21H, and an underdeck cargo extraction, according to some embodiments;

FIG. 21L: Schematically shows the container vessel crane of FIG. 21F moving over upper tier (of on-board cargo containers);

FIGS. 22A-C: Schematic diagrams of side view and front views, respectively, of a contracting travel tray, in accordance with some embodiments;

FIGS. 23A-C: Schematic diagrams of perspective views of a contracting travel tray, in accordance with some embodiments;

FIG. 24: Schematic diagram of a front view of a moored cargo vessel showing a vessel crane with quad spreader under deck extraction of cargo, in accordance with some embodiments;

FIG. 25: Schematic diagram of a top view of a cargo vessel with vessel cranes, in accordance with some embodiments;

FIGS. 26A-B: Schematic diagrams of a side view of a mega slope conveyor, in accordance with some embodiments;

FIGS. 27A-B: Schematic diagrams of a front view and side view, respectively of a mega slope conveyer in accordance with some embodiments;

FIGS. 28A-B: Schematic diagrams of a side view of a mega slope conveyor, in accordance with some embodiments;

FIG. 29: A flow chart of a mega STS system, in accordance with some embodiments of the present invention;

FIG. 30: A flow chart of a mega STS system, in accordance with some embodiments of the present invention;

FIG. 31: A flow chart of attachment of a container to a travel tray, in accordance with some embodiments of the present invention;

FIG. 32: A flow chart of cargo transfer from mega train to a mega carrier, in accordance with some embodiments of the present invention;

FIG. 33: A flow chart of cargo transfer from mega carrier to a mega crane, in accordance with some embodiments of the present invention;

FIG. 34: A flow chart of cargo transfer to a cargo vessel, in accordance with some embodiments of the present invention;

FIG. 35: A flow chart of cargo transfer to a vessel crane, in accordance with some embodiments of the present invention;

FIG. 36: A flow chart of cargo transfer using a mega slope, in accordance with some embodiments of the present invention;

FIG. 37: shows a flow chart of a method for relocating a cargo container on a cargo vessel from distal side of the cargo vessel to proximal side of the cargo vessel or vice versa, in accordance with some embodiments; and

FIG. 38: shows a flow chart of a method for relocating a cargo container on a cargo vessel from distal side of the cargo vessel directly to a shore, a truck, or a train or vice versa, in accordance with some embodiments.

### DETAILED DESCRIPTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the following description, various aspects of the invention will be described. For the purpose of explanation, specific details are set forth in order to provide a thorough understanding of the invention. However, it will also be apparent to one skilled in the art that the invention may be practiced without specific details being presented herein. Furthermore, well-known features may be omitted or simplified in order not to obscure the invention.

Some embodiments relate to mega ship to shore (STS) horizontal container transfer systems and methods of use thereof. According to some embodiments, the mega STS may include a mega train for conveying cargo containers from container stack to a mega carrier to be transported to the mega crane and/or mega slope, which may transfer the cargo containers to a modified cargo vessel. Alternatively, and/or additionally, the mega STS may include a mega crane and/or a mega slope to off load a cargo vessel, a mega carrier to transport the containers to a mega train and a mega train for conveying cargo containers to container stacks, thereby transferring cargo containers from the cargo vessel to the port. According to some embodiments, the mega STS may further include a system for attaching cargo containers to each other and/or to the tiers above and/or below them. According to some embodiments, the mega STS may provide a means of locking the attached cargo containers in place, e.g., on the deck of a modified cargo vessel.

Advantageously, the mega STS system may reduce human interference, e.g., by using automated systems. Additionally, advantageously the mega STS system may reduce the number of the moving vehicles, thereby reducing costs and/or emissions, increasing efficiency and/or speed of container transfer to and from cargo vessels Further, advantageously the mega STS system may reduce the time required to load and/or unload a cargo vessel, and thereby reduce port congestion and pre-berthing time outside ports. Furthermore, advantageously the mega STS systems may be used in conjunction with existing infrastructure.

According to some embodiments, the mega STS systems may increase the speed of container movement by using heavy load electric powered machinery, such as on rails, power winches, etc. According to some embodiments, the mega STS system may be configured for horizontal transport of multiple containers in each cycle, e.g., 24 containers. According to some embodiments, the mega STS system may be capable of moving a weight of each load ranging between about 1 ton to about 1,500 tons, between about 200 tons to about 1,000 tons, between about 250 tons to about 750 tons. Each possibility is a separate embodiment. According to some embodiments, the mega STS systems may be used for on deck and/or below deck cargo.

According to some embodiments, the mega STS systems may be used to horizontal transport standard international containers, such as, but not limited to containers that have a length of about 10 ft (about 3 m), about 20 ft (about 6.1 m), about 40 ft (about 12.2 m), about 45 ft (about 13.7 m), about 48 ft (about 14.6 m), about 53 ft (about 16 m) and/or any other length of cargo container. Each possibility is a separate possibility. Preferably, the mega STS systems may be used for containers with a length of about 40 ft (about 12.2 m). Optionally, for longer containers over 40 Ft different vessel bay scale and machinery may be implemented.

According to some embodiments, the mega STS systems may be used to transport standard international containers, such as, but not limited to containers having a width of about 8 ft (about 2.4 m).

According to some embodiments, the mega STS systems may be used to transport standard international containers, such as, but not limited to containers having a height that varies between about 8 ft (about 2.4 m) and about 10 ft (about 3 m) e.g., standard cube, high cube, etc. Each possibility is a separate embodiment. According to some embodiments, containers of the same height may be required in each tier and/or bay.

According to some embodiments, the mega STS systems may be autonomous, automatic, manual, controlled remotely and/or a combination thereof. According to some embodiments, the mega STS systems may be operated autonomously with sensors. According to some embodiments, the mega STS systems may include one or more sensors, such as movement sensors, accelerometer, gyroscope, magnetometer, GPS, optical sensors, pressure sensors and/or switches, mechanical sensors and/or switches, electromechanical sensors and/or switches, proximity sensors, etc. Each possibility is a separate embodiment.

According to some embodiments, the mega STS system may include a horizontal cargo movement cycle. According to some embodiments, each transport cycle may include at least three movement phases. According to some embodiments, the three movement phases may relate to loading and/or unloading of cargo. According to some embodiments, when loading the first movement phase may be transfer of the cargo containers from a mega train to a mega carrier. According to some embodiments, on loading the second movement phase may be transfer of the cargo containers from a mega carrier to a mega crane. According to some embodiments, on loading the third movement phase may be transfer of the cargo containers from a mega crane to a cargo vessel. According to some embodiments, the various systems and/or methods and/or movement phases disclosed herein may be related to each other and/or may not be separated.

According to some embodiments, the mega STS system may include various vehicles. As used herein, the term “vehicle” relates to a mega train, mega carrier, mega crane, mega slope and/or cargo vessel. According to some embodiments, the term “next vehicle” may refer to the next vehicles of a cargo movement cycle, e.g., mega train to mega carrier to mega crane to cargo vessel, and/or vice versa.

According to some embodiments, each vehicle may include an on-board wheel conveyor and/or a winch system. According to some embodiments, winch systems in all stages (e.g., for pulling of cargo horizontally) and/or vehicles may be used as secondary backup system and/or for accelerating a stage and/or method. According to some embodiments, each vehicle may include one or more travel wheels. According to some embodiments, one or more travel wheels may be motorized. According to some embodiments, each travel wheel may include a side brake system. According to some embodiments, each travel wheel may include a dual sided ratchet mechanism. According to some embodiments, each travel wheel may include a silicone coating, e.g., to prevent and/or reduce damage to goods stored inside cargo containers. According to some embodiments, each travel wheel may include an electrical current conductor to operate one or more engines, sensors, switches and/or locks on the travel tray. Optionally, the travel tray may be constructed, at least in part, from a conducting metal. Optionally, the travel tray may include one or more electric systems (e.g., wires, etc.) to operate one or more sensors, switches and/or locks on the travel tray and/or container.

According to some embodiments, each vehicle may include one or more power winches at each of its corners, e.g., two winches may be placed at the proximal ends and two winches (e.g., power winches) may be placed at the distal end of the vehicle. According to some embodiments, each winch may include an electric motor. According to some embodiments, each winch may include a cable and/or a winch hook, e.g., to connect to a cargo container, travel tray and/or row thereof. According to some embodiments, a pair of winches may be configured to pull cargo onto and/or off a vehicle. According to some embodiments, winches on the opposite side to the cargo loading and/or unloading winches may be configured to return a winch hook cable to its start position. According to some embodiments, the winch speed may be between about 1 km/h to about 10 km/h or more, between about 2 km/h to about 8 km/h, between about 3 km/h to about 6 km/h. Each possibility is a separate embodiment. Preferably, the winch speed may be about 4.8 km/h.

As used herein, the term “proximal” relates to the side most distant to the ocean, while the term “distal” relates to the closest to the ocean and furthest from the port.

According to some embodiments, a linked row of containers may be loaded from a one vehicle of the mega STS system to the next according to the following steps:

Step 1: First vehicle attaches to the next vehicle.

Step 2: Gates between vehicles open.

Step 3: Winch hook attaches to the 1^{st} travel tray of the first container of a linked row of containers.

Step 4: Power winch pulls a linked row of containers on board the next vehicle until the distal end is reached.

Step 5: When approaching the distal position, a power brake system is applied.

Step 6: Gates close after loading, for cargo securing.

Step 7: Next vehicle moves to the subsequent next vehicle.

Step 8: Opposite winch retrieves quickly hook to start position again.

Step 9: Process continues with subsequent next vehicle by implementing same steps.

These steps may be repeated until the cargo containers are loaded onto or unloaded from a cargo vessel.

According to some embodiments, a linked row of containers may be loaded from a one vehicle of the mega STS system to the next according to the following steps:

Step 1: First vehicle attaches to the next vehicle.

Step 2: Gates between vehicles open.

Step 3: Wheel conveyor moves containers on board the next vehicle until the distal end is reached.

Step 4: When approaching the distal position, a power brake system is applied.

Step 5: Gates close after loading, for cargo securing.

Step 6: Next vehicle moves to the subsequent next vehicle.

Step 7: Process continues with subsequent next vehicle by implementing same steps.

These steps may be repeated until the cargo containers are loaded onto or unloaded from a cargo vessel.

According to some embodiments, each transfer from one carrier to another may consist of a dual connection. According to some embodiments, a first carrier may connect to a second carrier using two or more outgoing connections. According to some embodiments, the flexible legs may be deployed by the first carrier against the second carrier.

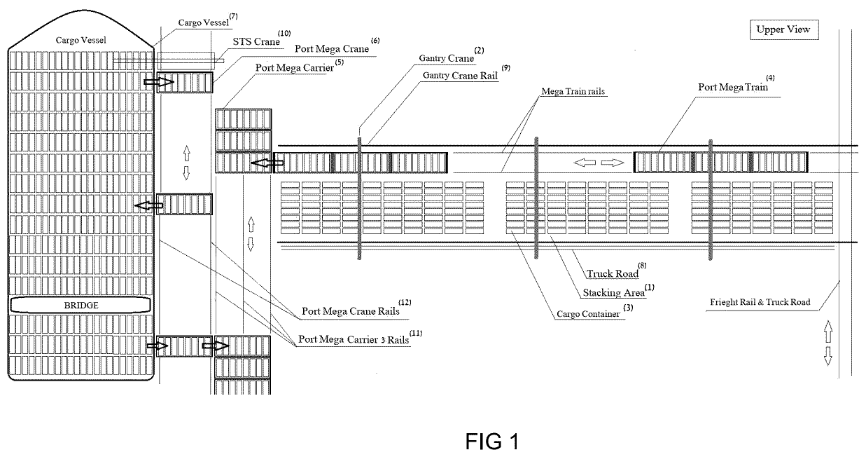

Reference is now made to FIG. 1, which is a top view of an overview schematic diagram of a port movement order of a mega STS system in accordance with some embodiments of the present invention. According to some embodiments, the port movement order may start at a container stacking area 1. According to some embodiments, a truck road 8 may run parallel to the stacking area, for loading and unloading cargo containers 3 onto trucks. According to some embodiments, a gantry crane 2 and/or a forklift may pick up a cargo container 3 (e.g., a 40 ft cargo container), and may place the container on a port mega train 4, which may run along a gantry crane rail 9. According to some embodiments, the containers may be locked to the travel tray on the carriages of the mega train. According to some embodiments, the mega train may move forward and/or backwards between gantry cranes 2 to collect the cargo containers faster, (e.g., 24 cargo containers). According to some embodiments, a mega train may run on two rail tracks. According to some embodiments, the rail tracks may have a gauge between about 10 m and about 15 m (e.g., 12 m).

According to some embodiments, the rail system may include at least one divergent track, which may further facilitate use of a second mega train. According to some embodiments, the first and second mega trains may alternate for continuous loading and/or unloading of containers.

According to some embodiments, a second train may move along the same rail tracks to collect cargo and/or deliver the cargo to a first train, which may be located near the mega carrier. According to some embodiments, a second mega train may move forward and/or backwards between gantry cranes, while a first mega train may be stationary to facilitate rapid loading and/or unloading.

According to some embodiments, as the mega train 4 approaches a mega carrier 5, at the seafront end (distal end) of the mega train tracks. According to some embodiments, a port mega carrier 5 may receive one or more rows of linked containers (e.g., each row may include 8 linked containers). According to some embodiments, the mega carrier 5 may progress along the mega carrier rails 11 to facilitate loading of rows of linked containers (e.g., a row of 8 linked containers may be loaded onto each carriage, the mega carrier may then move forward and/or backwards parallel to the seafront to load the next row of linked containers). Optionally, this stage may be repeated until a sufficient number of containers are loaded. For example, if this procedure was carried out 3 times with 8 linked containers in a row, then 24 containers would be loaded onto the mega carrier.

According to some embodiments, loading containers onto mega carrier carriages may include use of a winch (e.g., a power winch) and/or a wheel conveyor. According to some embodiments, the containers on the travel trays may be loaded from the mega train directly onto the carriages of the mega carrier. According to some embodiments, a mega carrier may travel along several rails 11 (e.g., 3 or 5 rail tracks), which may be parallel to the currently existing rail tracks 12 of the existing ship to shore crane 10, i.e., parallel to the seafront and anchored cargo vessel. According to some embodiments, a mega carrier rails may be perpendicular to the rails of the mega train. According to some embodiments, mega crane 6 may use the currently existing rail tracks 12 to move along the seafront. According to some embodiments, ship to shore cranes 10 and mega cranes 6 may be intermittently located on the same rails 12 alongside docked cargo vessels 7.

According to some embodiments, the mega carrier may convey the containers to a port mega crane 6. According to some embodiments, the mega crane 6 may load each row of containers onto a separate conveyor pad, e.g., a mega crane may receive 3 rows of 8 containers, which may be transferred from the mega carrier onto 3 separate conveyor pads. Each conveyer pad may then be lifted to the required tier of a cargo vessel 7.

According to some embodiments, standard ship to shore (STS) cranes 10 may work alongside one or more mega cranes 6 of the mega STS system, thereby maintaining current working procedures at the port to use both the current methods and the mega STS method disclosed herein. For example, an STS crane 10 may be used to unload underdeck and odd sized containers (e.g., other special cargo).

According to some embodiments, a machinery allocating plan may be used to combine efficient use of various and/or different cranes simultaneously. Since the various types of canes may be placed intermittently adjacent to the cargo vessel, and/or may be moved to the required locations, tasks may be effectively allocated.

According to some embodiments, each transfer from one vehicle to another vehicle may consist of a dual connection. According to some embodiments, proper connection between vehicles may facilitate transfer of a row of containers from a first vehicle to a second vehicle. According to some embodiments, connection may mean that alignment of coordinates (e.g., X axis=width and/or Y axis=length and/or Z axis=height) may be achieved. According to some embodiments, alignment of coordinates to the mega train may relate to the end stop position of the mega train relative to the mega carrier train tracks. According to some embodiments, alignment of coordinates to the mega carrier may relate to the end stop position of the mega carrier relative to the mega crane. According to some embodiments, alignment of coordinates to the mega crane may relate to the stop position of the mega crane relative to the cargo vessel.

According to some embodiments, the mega carrier may be aligned with a pre-defined position along the railway tracks e.g., 3 carriages, 3 Y axis points specified alongside mega carrier Y₁, Y₂, Y₃. According to some embodiments, the mega carrier may move back and forth between pre-defined positions along the railway tracks for loading and unloading a mega train, mega carrier, mega crane, mega slope and/or cargo vessel.

### Mega Train

As used herein, the term “mega train” relates to a series of railroad carriages moved as a unit by a locomotive or by integral motors, wherein the railroad carriages may be configured to fit a railroad gauge of between about 6 m (about 20 ft) to about 12 m (about 40 ft), preferably about 12 m, to support the length of a standard international cargo container.

As used herein, the term “cargo container” or “container” relates to large, metal compartments, such as, boxes, which may be used to transport goods by ship, train, and/or truck. Containers are required to conform to international standards and have standard sizes, e.g., length of 10 ft, 20 ft, 40 ft, 45 ft, 48 ft, or 53 ft, width of 8 ft, height of 8 feet 6 inches or 9 feet 6 inches. According to some embodiments, the container may be a standard 20 ft or 40 ft container.

According to some embodiments, the mega train may be configured to transport cargo containers in series, wherein the cargo containers may be aligned one after the other along their shortest dimension but maintaining their length parallel, in contrast to a conventional train in which cargo containers are aligned one after the other along their longest dimension. According to some embodiments, the mega train may be configured to progress along 2 or more train tracks in the direction of the shortest dimension (width) of a cargo container. According to some embodiments, the mega train may be configured to progress along 2 or more train tracks perpendicular and/or at an angle to the seafront. According to some embodiments, the railroad track gauge may be between about 5 m to about 15 m, between about 6 m to about 12 m, or between about 10 m to about 13 m. Each possibility is a separate embodiment.

According to some embodiments, the mega train may be powered by electricity, gas, fuel and/or may be a hybrid thereof. According to some embodiments, the mega train may be automatic, remotely controlled and/or manually controlled.

According to some embodiments, a gantry crane or forklift may lift a cargo container onto a mega train. According to some embodiments, a mega train may be loaded in advance, e.g., prior to the arrival of a cargo vessel.

According to some embodiments, the mega train may assist in loading and/or unloading a freight train to expedite loading and/or unloading and/or transfer to and from the stacking area.

According to some embodiments, a first mega train proximal side to the mega carrier may be a fixed positioned conveyor. Optionally, the fixed position conveyor may be configured to receive containers from a gantry crane and/or receiving cargo from a second mega train which may move along the rails to expedite loading and/or unloading of containers in the stacking area e.g., two or more trains may be used since the process of placing cargo onto the mega trains may be time consuming.

According to some embodiments, a forklift and/or gantry crane may place travel trays on the mega train prior to container loading. Optionally, containers in the stacking area may be without travel trays.

According to some embodiments, a cargo container may be placed, e.g., by a gantry crane or forklift onto a travel tray e.g., by a funnel guidance system, wherein the travel tray may be situated on the mega train. According to some embodiments, adjacent travel trays may be connected to each other. According to some embodiments, connection between travel trays may be by a flat latch system and/or flat twist lock system.

According to some embodiments, the travel trays may be attached to each other on opposite sides of a container at the base of their longest sides (length of the container), such that the containers may link to each other along their shortest dimension (width). According to some embodiments, the travel trays may be used to lock the containers to each other and/or to a vehicle, e.g., a cargo vessel. According to some embodiments, a series of containers may be linked together on carriages. According to some embodiments, each travel tray may be placed on several travel wheels. According to some embodiments, the travel wheels may be used to convey a travel tray with a container.

For example, a set of 8 containers loaded on travel trays and travel by wheel conveyor on the mega carrier in 3 stages up to a full load of 24 containers.

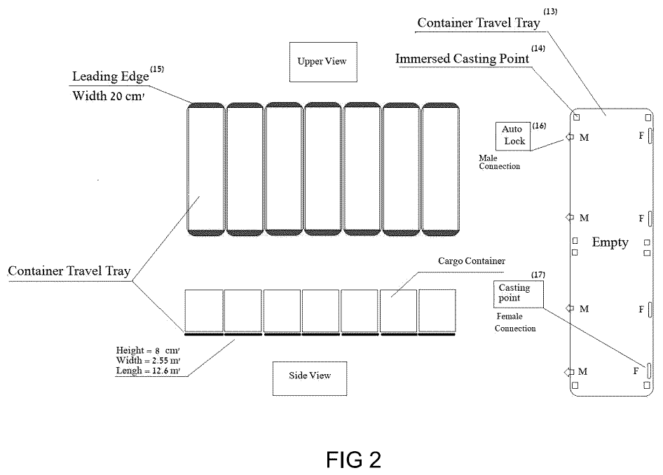

Reference is now made to FIG. 2, which shows schematic diagrams of various views of a travel tray, in accordance with some embodiments of the present invention.

According to some embodiments, a mega train with empty carriages may move alongside a stacking area, in order to reduce gantry cranes movement and/or to collect cargo faster. According to some embodiments, containers may be loaded and/or unloaded from a mega train by a gantry crane, forklift, etc. According to some embodiments, a forklift and/or gantry crane may place a container onto a travel tray 13 that may be located on a carriage of a mega train. According to some embodiments, the mega train may include one or more carriages.

According to some embodiments, container placement may be assisted by one or more guides, e.g., a funnel guide, which may optionally be similar to loading containers under the deck of a cargo vessel. According to some embodiments, a container travel tray 13 may facilitate horizontal movement of containers from port to vessel and vice versa. According to some embodiments, a travel tray may have a net thickness in the range of about 3 cm to about 20 cm about 3 cm to about 18 cm, between about 5 cm to about 15 cm, or between about 8 cm to about 12 cm, preferably about 7 cm. Each possibility is a separate embodiment. According to some embodiments, the travel tray may barely affect the total cargo height onboard a cargo vessel, due to its thinness. According to some embodiments, a travel tray may include side reinforcement e.g., to maintain and/or increase structural strength. According to some embodiments, the travel tray may be sufficiently supportive to carry the weight of a container, e.g., 30 tons. According to some embodiments, the dimensions of the travel tray may be adjusted to fit to the dimensions of the cargo vessel and/or the dimensions of various containers. According to some embodiments, at tiers above deck, a travel tray may have a length longer than the length of a container, e.g., the length of a travel tray may be 40 cm longer than the length of a 40 ft container, with a 20 cm extension on each end, e.g., at tiers above deck. Optionally, such a length may be suitable for use on and/or in a mega train, mega carrier, mega slope, mega crane and/or tiers above deck. According to some embodiments, these extensions may be the leading edge of a travel tray 15 (e.g., FIG. 2). For example, a travel tray may have a length in the range between about 6 m to about 20 m, between about 8 m to about 15 m, between about 10 m to about 14 m, preferably about 12.6 m. Each possibility is a separate embodiment. According to some embodiments, the width of a travel tray may be the width of a standard container with about 1.5 cm of side reinforcement, i.e., about 2.6 m. According to some embodiments, a travel tray may include edges curved at the sides and/or front. According to some embodiments, the leading edge may be coated by silicone and/or another shock absorbing material.

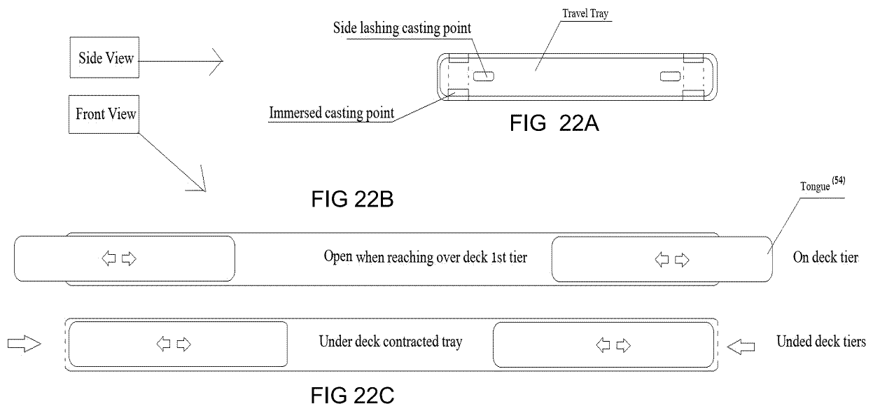

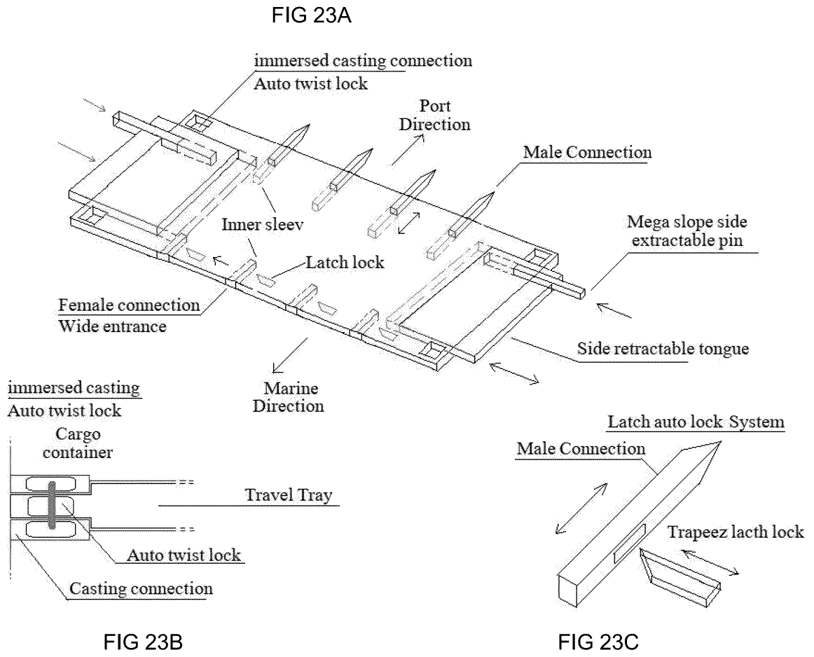

According to some embodiments, the travel tray may be a contracting travel tray (e.g., FIGS. 22A-C and FIGS. 23A-C). According to some embodiments, a contracting travel tray may be used in a contracted configuration for under deck cargo storage, since bay length at cargo vessel under deck is limited to a standard 40 ft length container unlike over deck bays space. According to some embodiments, one or more leading edges (tongues) of a contracting travel tray may be reversibly retractable e.g., by retracting one or more leading edges within the structure of a contracting travel tray. According to some embodiments, when retracted a travel tray may have a length in the range between about 5 m to about 18 m, between about 6 m to about 14 m, between about 8 m to about 13 m, preferably about 12.2 m. Each possibility is a separate embodiment.

According to some embodiments, the travel tray may be approximately the same width as a standard international shipping container (e.g., 2.4 m). According to some embodiments, the travel tray may have a width in the range between about 1.5 m to about 3.5 m, between about 2 m to about 3 m, preferably about 2.5 m. Each possibility is a separate embodiment.

According to some embodiments, each travel tray may include two or more immersed casting points 14 (e.g., 4 or 8 or 16 immersed casting points). According to some embodiments, the casting points may include and/or may be accessible by an automatic twist lock. According to some embodiments, the automatic twist locks may be operated electrically and/or electromagnetically and/or mechanically. According to some embodiments, these automatic twist locks may lock the containers to the travel tray (e.g., FIG. 2). For example, a 40 ft container may use 4 casting points to connect to a travel tray, while two 20 ft containers may use 8 casting points to connect to a travel tray.

According to some embodiments, the twist locks may be automatically, semi-automatically, manually and/or remotely operated.

According to some embodiments, the travel trays may further include two or more immersed casting points on their edges, which may be male M or female F casting points. According to some embodiments, the male casting points may include an automatic lock 16. According to some embodiments, interaction between the male 16 and female 17 casting points of adjacent travel trays may lock adjacent trays together (e.g., FIG. 2, FIGS. 23A-C). According to some embodiments, the automatic locks may be operated electromagnetically. For example, 8 travel trays may connect one to the other by 2 distal automatic locks 16 which connect to the next travel tray proximal immersed casting points 17 to form a row of linked containers. According to some embodiments, the travel trays may include one or more casting connections 20 on their sides, which may be configured to facilitate lashing, if required (e.g., FIG. 2).

According to some embodiments, travel trays may fit above several travel wheels (not shown). According to some embodiments, connecting between travel trays may occur when travel wheels under a first travel tray stop and a second travel tray may be moved to the first travel tray until a connection is formed. Optionally, this action may be repeated until a row of linked containers is formed e.g., until 8 travel trays may be connected.

According to some embodiments, since the casting points are immersed, and the travel tray is thin it may not affect the total cargo height onboard a cargo vessel. According to some embodiments, cargo vessels may include space (e.g., on deck, between bays, etc.) facilitating the use of travel trays. According to some embodiments, travel trays may be used on a vehicle, the cargo vessel and/or in port.

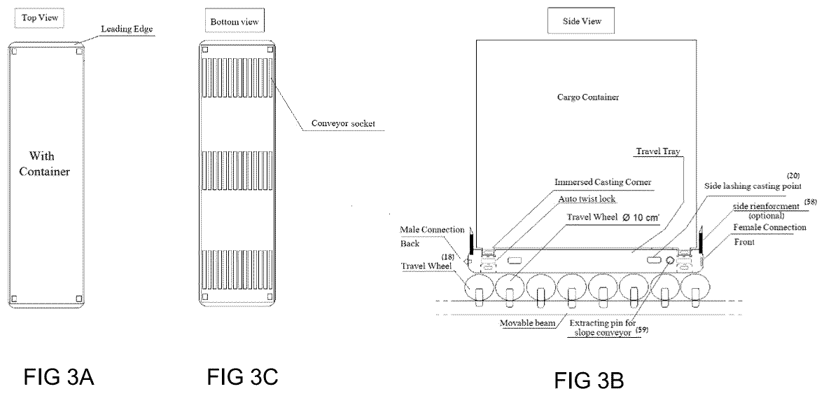

Reference is now made to FIGS. 3A-C, which are various views of profile schematic diagrams of a travel tray and travel wheels, in accordance with some embodiments. According to some embodiments, the leading edge of the travel tray may lie on a series of travel wheels 18. According to some embodiments, each travel wheel may have a width of between about 5 cm to about 10 cm, between about 10 cm to about 15 cm, between about 15 cm to about 20 cm, between about 20 cm to about 25 cm, or between about 25 cm to about 30 cm, preferably 20 cm. Each possibility is a separate embodiment. According to some embodiments, each travel wheel may have a diameter of between about 5 cm to about 10 cm, between about 10 cm to about 15 cm, between about 15 cm to about 20 cm, or between about 20 cm to about 25 cm, preferably 10 cm. Each possibility is a separate embodiment.

According to some embodiments, a travel tray may include one or more sockets under its structure (e.g., FIG. 3B). Optionally, the slope conveyer's chains may connect to one or more travel tray sockets e.g., as gripping points to hold the travel tray. Optionally, the travel tray sockets may assist in preventing slippage of the travel tray. Optionally, the travel tray sockets may convey the container up the incline and/or down the slope of a mega slope.

According to some embodiments, the travel tray may allow horizontal movement of containers from a port onto a cargo vessel deck in contrast to the vertical movement of present ship to shore transfer systems. According to some embodiments, the mega STS systems may make use of existing space (e.g., on deck and/or under deck) on cargo vessels, allowing use of the travel trays. According to some embodiments, travel trays may be used in marine port areas, etc. According to some embodiments, travel trays may be released from containers prior to moving the containers to the stacking area of a port and/or prior to loading on land transport e.g., truck, freight train, etc.

According to some embodiments, each travel wheel may be connected to a fixed beam placed on vehicle's carriage and/or pad. According to some embodiments, each travel wheels may have motorized brake capability. According to some embodiments, the travel wheels may form a wheel conveyor. According to some embodiments, the container with attached travel tray may be placed onto the travel wheels. According to some embodiments, the container with travel tray lowered onto the travel wheels may travel in a horizontal direction.

According to some embodiments, the travel wheels may be fixed in place on one or more elements of the mega STS systems (e.g., mega train, mega carrier, mega crane, and/or cargo vessel). According to some embodiments, the travel wheels may be attached to a conveyor on one or more elements of the mega STS systems (e.g., mega train, mega carrier, mega crane, and/or cargo vessel). According to some embodiments, travel trays may travel on travel wheels horizontally from one place to another by wheel conveyors.

According to some embodiments, the travel wheel diameter may be between about 10 cm to about 50 cm, or between about 25 cm to about 40 cm. Each possibility is a separate embodiment. Preferably, the travel wheel diameter may be 10 cm. According to some embodiments, travel wheels may be spaced between about 10 cm to about 100 cm apart, between about 15 cm to about 50 cm apart, or between about 20 cm to about 30 cm apart. Each possibility is a separate embodiment. Preferably, the travel wheels may be spaced 20 cm apart.

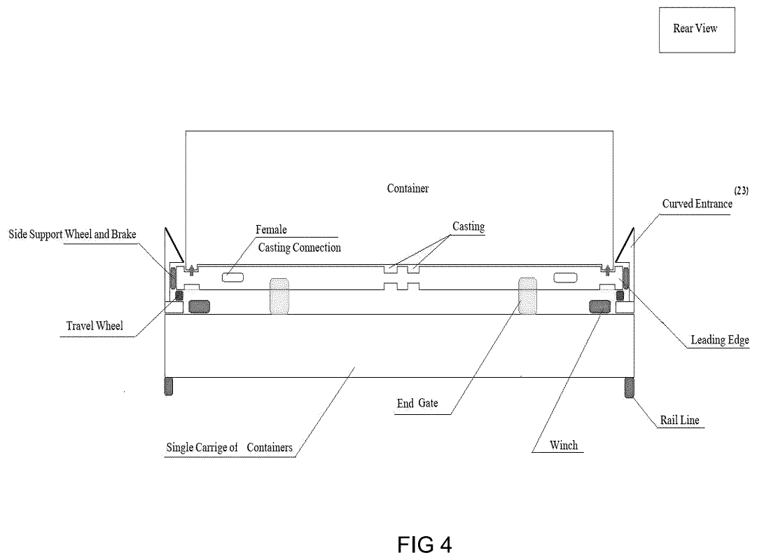

Reference is now made to FIG. 4, which is a schematic diagram of a rear view of a container loaded onto a mega train, in accordance with some embodiments of the present invention. According to some embodiments, side support wheels 19 may be connected to each carriage/pad conveyor. According to some embodiments, the side support wheels 19 may keep the travel trays on the central line of movement. According to some embodiments, the mega train carriage may include a curved entrance and/or funnel guide 23. According to some embodiments, the curved entrance and/or funnel guide 23 may assist gantry crane placement of a container on the travel tray.

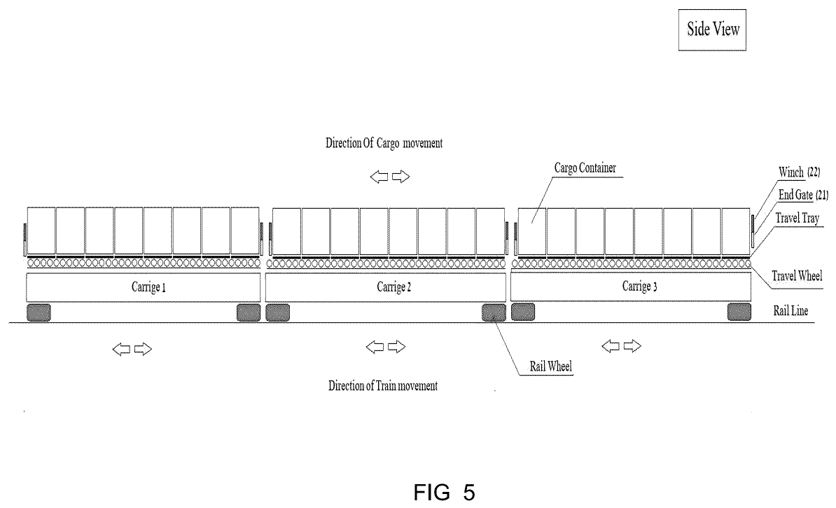

Reference is now made to FIG. 5, which is a schematic diagram of a side view of a mega train, in accordance with some embodiments. According to some embodiments, the purpose of the mega train may be to bring containers (e.g., 24 containers) from a cargo stacking area to a cargo vessel parallel rail and vice versa. According to some embodiments, the mega train may include one or more carriages (e.g., 3 carriages) which run on train tracks. According to some embodiments, the train tracks may have a gauge of between about 6 m to about 8 m, between about 8 m to about 10 m, between about 10 m to about 12 m, or between about 12 m to about 14 m. Each possibility is a separate embodiment. Preferably, the train tracks may have a gauge of about 12 m.

According to some embodiments, the mega train may have a chassis height of between about 1 m to about 2 m, between about 2 m to about 3 m, between about 3 m to about 5 m. Each possibility is a separate embodiment. Preferably, the mega train may have a chassis height of about 3 m. According to some embodiments, the mega train may have a length between about 20 m to about 60 m, between about 60 m to about 80 m, between about 80 m to about 100 m.

According to some embodiments, end gates 21 may be located on the corners of each carriage. According to some embodiments, the end gates 21 may be configured to secure cargo on board. According to some embodiments, the end gates may open during cargo loading and/or unloading. According to some embodiments, the end gates may close once cargo has been loaded and/or unloaded. According to some embodiments, one or more winch engines 22 may be located adjacent to the end gates. According to some embodiments, the winch engines 22 may be configured to facilitate pulling cargo from one vehicle onto the next vehicle. According to some embodiments, one or more mega trains may be operated on the same rail tracks, which may increase capacity.

According to some embodiments, the containers on the travel trays may ride over, along and/or on travel wheels of a conveyor. According to some embodiments, the travel wheels may fit under a travel tray. According to some embodiments, the travel wheels may include a high braking capability system, e.g., a power break in each travel wheel. According to some embodiments, the travel wheels may be motorized.

According to some embodiments, the mega train may include one or more winches e.g., to pull a row of linked containers off a mega carrier when unloading. According to some embodiments, the winch may be able to pull a row of linked containers at a speed of between about 3 km/h and 10 km/h, e.g., winch pulling speed may be 5 km/h.

According to some embodiments, the containers may be picked by a gantry crane from a stacking area and placed on the mega train according to the central planner's program for loading and unloading.

According to some embodiments, the travel wheels may form a conveyor belt, along which the containers may travel, e.g., a wheel conveyor belt, a roller conveyor belt, etc. According to some embodiments, the containers with travel trays may be conveyed from the mega train to the mega carrier. For example, the first 8 containers with travel trays may travel from the mega train onto the mega carrier, then the second row and the third rows of the mega carrier may then be filled.

### Mega Carrier

As used herein, the term “mega carrier” relates to a series of railroad cars moved as a unit by a locomotive or by integral motors, wherein the railroad cars are configured to carry a series of mega train carriages (e.g., 8 linked mega train railroad cars), and may include a series of wheels configured to fit a series of train tracks (e.g., 5 tracks), wherein the total width of the mega carrier is at least the length of 8 linked travel trays (about 20 m).

According to some embodiments, the mega carrier may be configured to transport a series of mega train carriages, wherein the mega train rail cars may be linked one after the other along their longest dimension (length) of the linked cargo containers. According to some embodiments, the mega carrier may be configured to progress along one or more train tracks in a direction perpendicular to the mega train's direction of travel (along the containers longest dimension (length)). According to some embodiments, the mega carrier may be configured to progress along one or more train tracks parallel to the seafront, e.g., 3, 4, 5, 6 or 7 train tracks. According to some embodiments, the mega carrier may progress alongside the cargo vessel along one or more dedicated rail tracks (e.g., 2, 3, 4, 5, dedicated train tracks) which may be parallel to the existing two train tracks of a standard STS crane and/or which may be shared with one or more mage cranes (e.g., FIG. 1).

According to some embodiments, the mega carrier may be powered by electricity, gas, fuel and/or may be a hybrid thereof. According to some embodiments, the mega carrier may be automatic, remotely controlled and/or manually controlled.

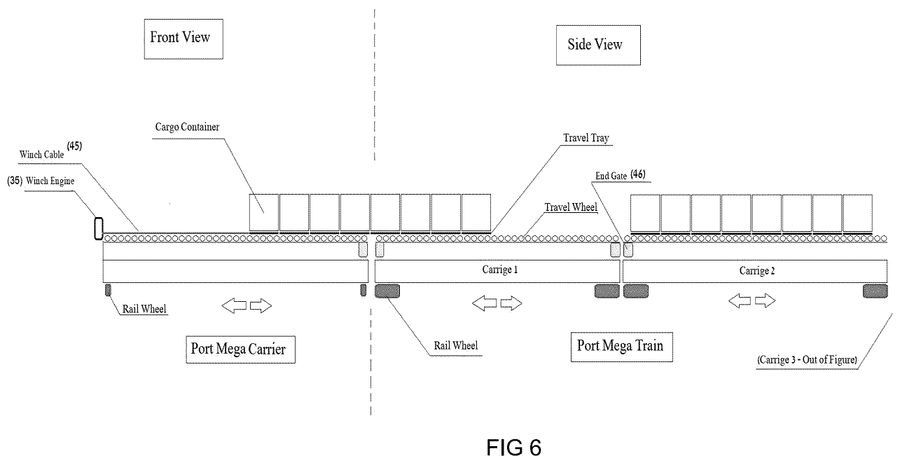

Reference is now made to FIG. 6, which is a schematic diagram of transfer of containers from a mega train to a mega carrier, in accordance with some embodiments.

According to some embodiments, the mega carrier may include at least two parallel carriages (e.g., 3 carriages), which may include wheeled conveyors like those of the mega train. According to some embodiments, each wheeled conveyor may load a row of linked containers onto one carriage simultaneously (e.g., 8 containers, with a total capacity of 24 containers). For example, up to 750 tons of total cargo gross weight may be transported when the mega carrier is full.

According to some embodiments, each carriage of the mega carrier may include two motorized wheel conveyors, e.g., one at each side of the carriage. According to some embodiments, each carriage may also include a set of stoppers and/or gates 46 at the carriage corners. According to some embodiments, each carriage may also include a winch at each corner. According to some embodiments, each winch may include a winch engine 35, winch cable 45 and winch hook. According to some embodiments, winch cables 45 may include a hook 27 on their distal end. Optionally, a winch hook may be configured for loading and/or unloading the containers by connecting to the travel tray with an automatic lock, e.g., male connection, to casting point, e.g., female connection. Optionally, a winch hook may attach to a side lashing connection socket.

According to some embodiments, the mega carrier may travel parallel to the existing two rail tracks of the STS crane. According to some embodiments, the mega carrier may travel forward and/or backwards along the rail tracks. According to some embodiments, one or more mega carriers may be operated simultaneously on the same rail tracks, which may increase capacity.

According to some embodiments, the mega carrier may have a length of between about 20 m to about 40 m, between about 40 m to about 50 m, or between about 50 m to about 60 m, preferably 45 m. Each possibility is a separate embodiment. According to some embodiments, the mega carrier may have a width of between about 10 m to about 15 m, between about 15 m to about 20 m, or between about 20 m to about 30 m, preferably about 25 m. Each possibility is a separate embodiment. According to some embodiments, the length of the mega carrier may be increased by addition of one or more carriages.

For example, in FIG. 6, a row of linked containers may be transferred from a mega train to a mega carrier. Optionally, a mega carrier (front view) may approach a mega train (side view), one or more winch hooks from the mega carrier may pull a row of linked containers from the first carriage of the mega train onboard the mega carrier. Simultaneously, a wheel conveyor of the second carriage of the mega train may move a second row of linked container to the first carriage of the mega train, and so on. After pulling a first row of linked containers onboard the mega carrier has been completed, the mega carrier may move forward and/or backwards to load a second row of linked containers, and so on. The mega carrier may stop at a pre-determined positions near the mega train to line up the carriages of the mega train and the mega carrier. The mega carrier may then transfer the containers to the mega crane.

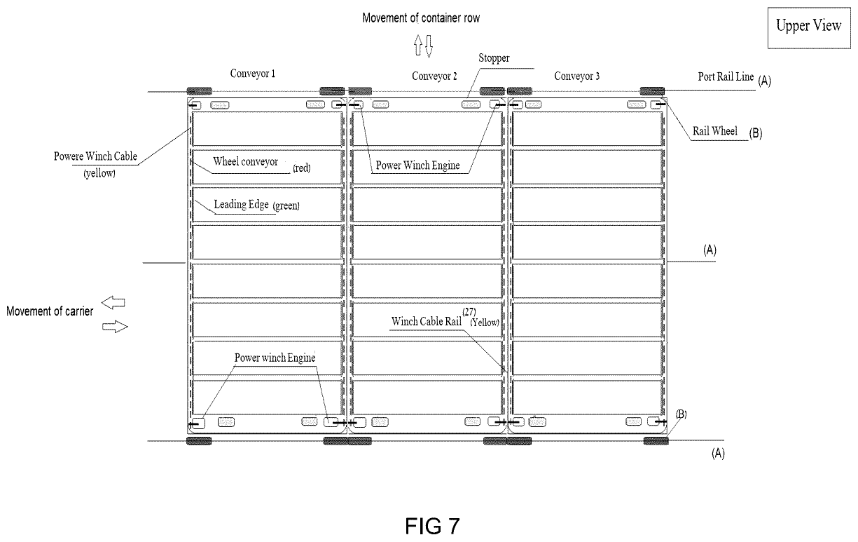

Reference is now made to FIG. 7, which is a schematic diagram of a top view of a mega carrier loaded with containers, in accordance with some embodiments. According to some embodiments, a mega crane may include systems, such as winches, gates, winch cable rail 27, etc., which may guide the winch hooks to a casting point and/or side lashing points at the sides on a travel tray, and once connected, a wheel conveyor and/or winch may pull a row of linked containers onboard the mega carrier.

According to some embodiments, winch cables may roll alongside travel wheels on one or more winch cable rails, until a winch hook is attached to the first travel tray casting point. According to some embodiments, an opposite winch may return the winch hook to its start position.

According to some embodiments, each carriage on the mega carrier may include one or more motorized wheel conveyors on its sides. According to some embodiments, the wheels conveyors may include one or more power brakes. According to some embodiments, a set of stoppers and/or gates at the proximal and distal ends of the carriage. According to some embodiments, the mega carrier may include one or more cabins allowing operator tasks. According to some embodiments, the mega carrier may be operated autonomously, automatically, remotely and/or manually. According to some embodiments, an engine may be located on either side of the mega carrier.

According to some embodiments, each carriage may include four power winches with winch engines on the corners of each carriage of the mega carrier. According to some embodiments, the winches may be used for higher speed loading and/or unloading and/or as backup system to the wheel conveyor. According to some embodiments, winch cables may connect to a travel tray by one or more corner casting points and/or casting points on the travel tray sides located at the leading edge and/or the sides, e.g., with an automatic twist lock.

According to some embodiments, the distal end of the wheel conveyor may include an end stopper and/or a gate, which during loading may be closed. According to some embodiments, the proximal end of the wheel conveyor may include an end stopper and/or a gate, which during loading may be open. According to some embodiments, the proximal and distal gates may be closed once the row of linked containers has been loaded onto the carrier in order to secure the containers. According to some embodiments, the carrier may then move forward to receive the next row of linked containers. According to some embodiments, containers may be loaded onto the mega carrier from one side and may be unloaded from the other side the mega carrier.

For example, the mega carrier may stop each time at three positions near the wheel conveyor of the mega train to load and/or unload each carriage of the mega carrier and then at three positions near the mega crane to load and/or unload each pad of the mega crane.

### Mega Crane

As used herein, the term “mega crane” relates to a type of large dockside crane for loading and unloading containers from container ships. According to some embodiments, the mega crane may include a supporting framework, e.g., the mega crane may be similar in size to existing STS cranes and may travel alongside cargo vessels by the same rail tracks. Optionally, the mega crane may traverse the length of a quay or yard on a rail track mega crane. According to some embodiments, the mega crane may include a system of cables, and/or one or more conveyor pads.

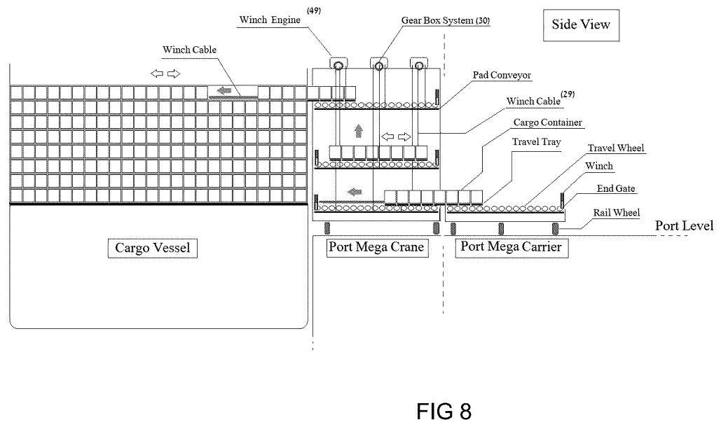

Reference is now made to FIG. 8, which is a schematic diagram of a mega carrier stopped at a mega crane alongside a cargo vessel for loading and unloading, according to some embodiments. According to some embodiments, the mega crane may be positioned alongside a cargo vessel. According to some embodiments, the mega crane may include one or more conveyor pads, e.g., 3 conveyor pads. According to some embodiments, each conveyor pad may include one or more power winches to pull rows of connected containers onto the conveyor pad from the mega carrier and/or cargo vessel. According to some embodiments, each conveyor pad may include wheeled conveyors, over which the row of linked containers may move. According to some embodiments, wheeled conveyors may carry the containers to and from the cargo vessel.

According to some embodiments, since some cargo vessels may be at various distances and/or heights from the base of the mega crane (e.g., due to their shape, etc.), the mega crane may be capable of extending a conveyor to the cargo vessel in order to close the gap.

According to some embodiments, the mega carrier may stop at a stopping point near the mega crane. According to some embodiments, the distal gate of the mega carrier and the proximal gate of the mega crane may open to allow passage of a row of linked containers. For example, when the mega carrier arrives at a stop point near a port mega crane, gates open on a first mega crane conveyor pad. Then, the wheeled conveyor and/or one or more winches of the mega crane's first conveyor pads may pull a row of linked containers on board the first conveyor pad.

According to some embodiments, a mega crane may be designed to work alongside existing technology, e.g., a standard STS crane. According to some embodiments, the dimensions of the mega crane (e.g., width, length) may be similar to those of a standard STS crane. According to some embodiments, the mega crane structure may be much stronger than that of a standard STS crane in order to support a massive load, e.g., up to 500 tons, up to 750 tons, etc. According to some embodiments, the mega crane may have up to two conveyor pads in the air at once.

According to some embodiments, the mega crane may include one or more power winch engines 49 the top of its structure. Optionally, the winch engines may run a system of cables 29, which may be attached to pad conveyors at the sides and/or corners or each pad, (e.g., 10 cables for each conveyor pad, 5 per side).

According to some embodiments, the winch engines may include a gear box system 30. According to some embodiments, the gear box system may facilitate operation of multiple tasks simultaneously, e.g., a gear and clutch system may be applied when 2 or 3 pads need to be lifted and/or lowered simultaneously. According to some embodiments, pad conveyors may ascend and/or descend secured by one or more leading vertical beams at the corners of the structure running from top to bottom.

According to some embodiments, a row of linked containers may be transferred from a mega carrier onto a first pad conveyor of a mega crane. According to some embodiments, the first pad conveyor may be lifted to the level of the upper tier and/or to the destination tier of containers on the cargo vessel. According to some embodiments, simultaneous to lifting the first pad conveyor, the mega carrier may move forward such that a second row of linked containers may be transferred from a mega carrier onto a second pad conveyor of a mega crane. According to some embodiments, the second pad conveyor may be lifted to the level of the destination tier of containers on the cargo vessel. According to some embodiments, simultaneous to raising the second pad conveyor, the mega train may move forward such that a third row of linked containers may be transferred from a mega carrier onto a third pad conveyor of a mega crane. According to some embodiments, one or more pad conveyors may be in motion simultaneously. According to some embodiments, the third pad conveyor may be lifted to the level of the destination tier of containers on the cargo vessel.

According to some embodiments, once the pad conveyor has unloaded its load of containers onto a cargo vessel, it may be moved to a stand-by position while one or more additional pad conveyors are unloaded. According to some embodiments, the cargo vessel may include one or more wheeled conveyors and/or winches for loading a row of linked containers from a pad conveyor onto the deck of a cargo vessel. According to some embodiments, in such a manner, a row of linked containers may be transferred from a mega carrier by a mega crane to a cargo vessel, and vice versa.

According to some embodiments, the pad conveyors may be located one above the other. According to some embodiments, the pad conveyors may be loaded and/or unloaded and/or raised and/or lowered individually, and/or simultaneously. According to some embodiments, each mega carrier carriage may be disconnected from the mega carrier and may be used as a pad conveyor by the mega crane.

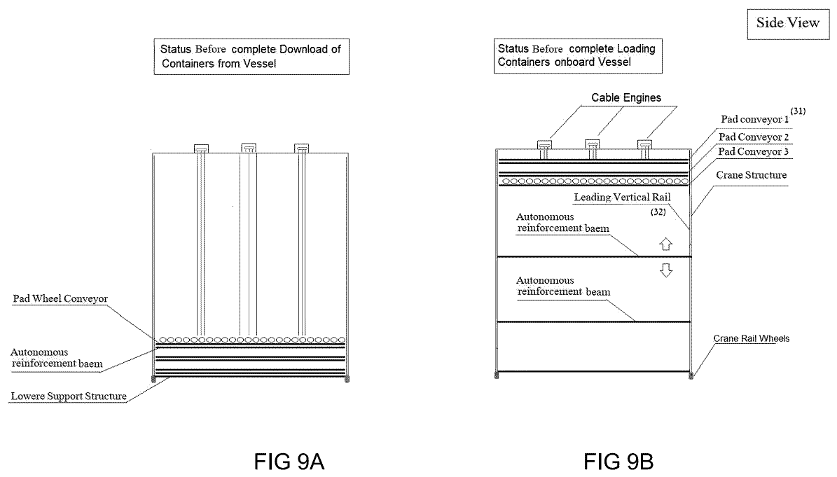

Reference is now made to FIGS. 9A-B, which are schematic diagrams of side views of a mega crane after complete unloading and loading containers onto a cargo vessel, respectively, in accordance with some embodiments.

According to some embodiments, the mega crane wheels gauge may be between about 10 m to about 15 m, between about 15 m to about 20 m, between about 20 m to about 30 m, or between about 30 m to about 45 m, preferably 18.2 m. According to some embodiments, since the width of a mega crane may be between 15 m to about 18.2 m, preferably 14 m, two or more cranes may work in adjacent bays simultaneously. Optionally, due to the distance between supportive legs and/or buffer to buffer which may be same width as the mega crane width. Each possibility is a separate embodiment. According to some embodiments, the width of a mega crane may be similar to that of a conventional STS crane (about 18.2 m) travel wheel gauge. According to some embodiments, the width of a mega crane may be able to receive a row of linked containers (e.g., length of 8 linked containers with travel tray may be between about 12 m to about 13 m).

According to some embodiments, the mega crane may travel along the same rail tracks as an existing STS crane. According to some embodiments, the height of a mega crane may be between about 30 m to about 40 m, between about 40 m to about 50 m, between about 50 m to about 60 m, or between about 60 m to about 80 m, preferably 50 m. Each possibility is a separate embodiment. According to some embodiments, the height of a mega crane may be as high as and/or higher than the height of the upper tier of containers on a cargo vessel, in contrast to the apex point of a conventional STS crane (about 80 m).

According to some embodiments, the mega crane may include two edge positions. According to some embodiments, the first edge position (e.g., FIG. 9A) all the pad conveyors may be at the bottom of the mega crane, e.g., when the first pad conveyor begins to receive a first row of linked containers from the mega carrier, and/or before unloading of the last row of linked containers is complete (depending on the direction of cargo flow). According to some embodiments, in this state, all conveyor pads may be in their lowest positions. According to some embodiments, the lowest level of the first pad conveyor may be between about 1 m to about 2 m, between about 2 m to about 3 m, or between about 3 m to about 5 m above the ground, preferably about 3 m (e.g., above the travel wheels and above the second and third pad conveyors). Each possibility is a separate embodiment.

According to some embodiments, in the second edge position (e.g., FIG. 9B) all the pad conveyors may be at the top of the mega crane, e.g., when the last pad conveyor begins to receive a first row of linked containers from the cargo vessel, and/or before transferring (to the cargo vessel) the last row of linked containers is complete (depending on the direction of cargo flow). According to some embodiments, in this state, all conveyor pads may be in their highest positions. According to some embodiments, the highest level of the first pad conveyor may be between about 1 m to about 2 m, between about 2 m to about 3 m, below the top of the mega crane. Each possibility is a separate embodiment.

According to some embodiments, pad conveyors 31 may ascend and/or descend secured by one or more leading vertical rails 32 at the corners of the structure running from top to bottom. According to some embodiments, pad conveyors may be similar to the carriages of a port mega carrier. According to some embodiments, the pad conveyors may lift the load to and/or from the cargo vessel. According to some embodiments, rows of linked containers may be loaded on to the mega crane from one side by the mega carrier and unloaded from the opposite side (of the mega crane) to the cargo vessel. According to some embodiments, mega crane may use one or more counterweights to reduce the required engine power.

For example, a mega carrier may deliver a row of 8 linked containers to a mega crane first pad conveyor. Then the next row of 8 linked containers may be loaded from mega carrier to a second pad conveyor, and the next row of 8 linked containers may be loaded onto the third pad conveyor. Simultaneously, while the second pad conveyor is loaded, the first pad conveyor may be lifted to reach the highest level of cargo needed to be loaded onto a cargo vessel. Then, at the same time the second pad conveyor may be lifted, and the third pad conveyor may receive a third row of 8 linked containers from mega carrier.

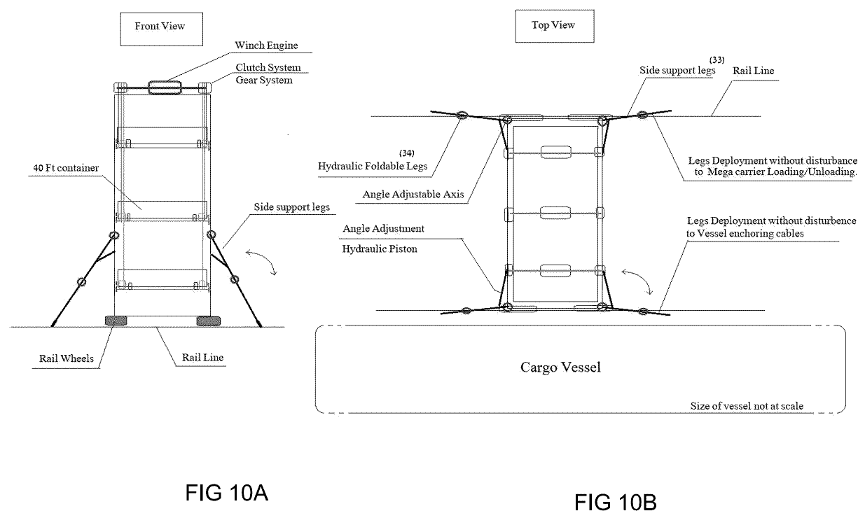

Reference is now made to FIGS. 10A-B, which are schematic diagrams of a front top views, respectively, of a mega crane with reinforcing legs in accordance with some embodiments. According to some embodiments, at least part of the front of the mega crane support framework may remain open such that containers may be transferred to and/or from a cargo vessel at any height. According to some embodiments, reinforcement of the mega crane structure may be performed by one or more side support legs 33. According to some embodiments, the side support legs 33 may be located on the front and/or rear corners of the support framework. According to some embodiments, the one or more side supporting legs may be configured to be adjustable and/or foldable 34 e.g., close to the sides of mega crane so as not to interfere with the cargo vessel mooring cables from one side, and/or not to interfere with loading and/or unloading of the mega carrier from the other side. According to some embodiments, side support legs may be folded against the superstructure of the mega crane when the mega crane is not in use, and/or during movement of the mega crane from one location to another along the waterfront e.g., during movement between bays of the vessel.

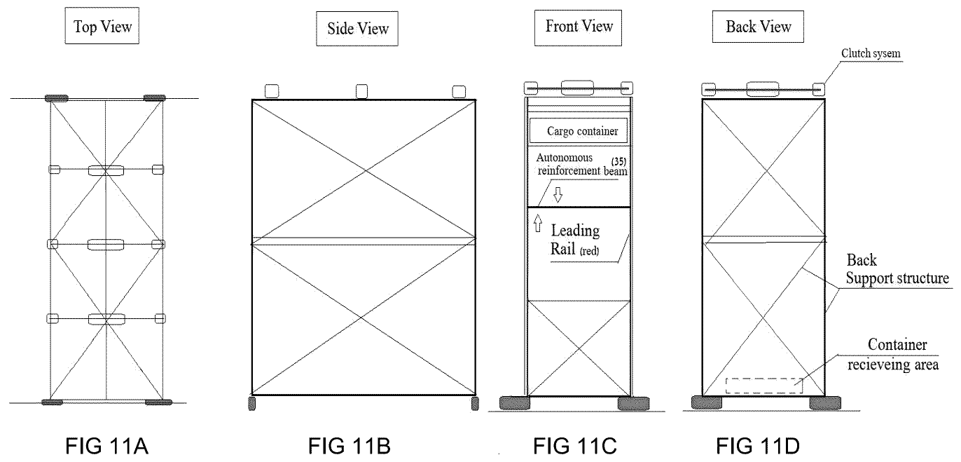

Reference is now made to FIGS. 11A-D, which are schematic diagrams of top, side, front, and back views, respectively, of a mega crane in accordance with some embodiments. According to some embodiments, the side and/or rear framework structures of the mega crane may include one or more support beams, e.g., diagonal supporting beams and/or crossbeams, to reinforce the framework structure.

According to some embodiments, the front of the mega crane (facing the cargo vessel) may be partially and/or completely open without support beams to facilitate loading and/or unloading of cargo, e.g., from the height of a standard cargo deck and/or tier. According to some embodiments, the mega crane structure may be maintained stable by one or more leading rails. According to some embodiments, leading rails may be installed on the inner corners of the mega crane structure to prevent pad conveyors from moving sideways during ascent and descent.

According to some embodiments, the mega crane may include one or more autonomous reinforcement beams 35. According to some embodiments, the reinforcement beams 35 may extend between the front sides of the front framework structures. According to some embodiments, the mega crane may deploy the reinforcement beams 35 automatically. According to some embodiments, reinforcement beams may be deployed once one or more pad conveyors ascend to reach a designated height. According to some embodiments, the mega crane may autonomously deploy the reinforcement beams to 25%, 50%, 75% of height to secure structure when as the mega crane lifts load. According to some embodiments, reinforcement may be required to prevent bending, buckling and/or failure of the mega crane framework front structure when lifting the weight of one or more rows of linked containers.

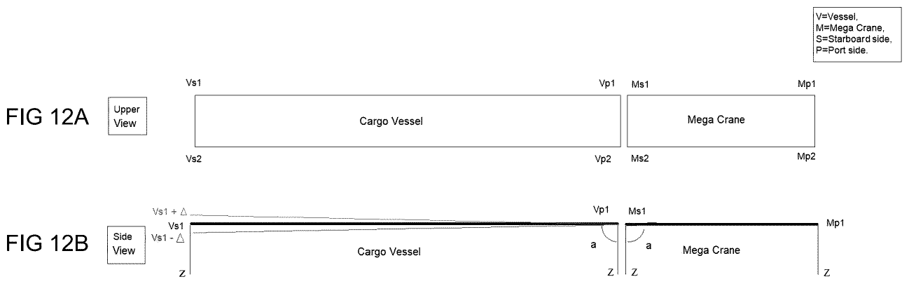

Reference is now made to FIGS. 12A-B are schematic diagrams of a cargo vessel and mega crane adjustment in accordance with some embodiments of the present invention. According to some embodiments, adjustment may be required for correct alignment between the mega crane and the cargo vessel. According to some embodiments, correct alignment may be required such that the row of linked containers may fit into a cargo vessel bay along the wheeled conveyor.

According to some embodiments, positional data may be transferred from the cargo vessel to the mega crane for proper adjustment. According to some embodiments, the mega crane may compensate for movement of the cargo vessel using one or more cables. According to some embodiments, the mega crane must be parallel to the cargo vessel, this may be achieved by mooring the cargo vessel parallel to the waterfront and the parallel rail lines of the mega crane.

The height of the mega crane Ms1 should be slightly greater than the height of the cargo vessel Vp1 when loading the cargo vessel and opposite when unloading. According to some embodiments, an adjustment system (e.g., laser system) at the edge of each pad conveyor may adjust the pad conveyor height by the mega crane cables.

Minor longitudinal roll angle of the cargo vessel is of importance, since the containers are pulled over wheeled conveyors, angle awareness may be important for applying brake intensity against the speed of container movement, even in the case of a minor deviation from compete leveled.

According to some embodiments, the mega crane pad conveyor may not be tilted at in any direction. Optionally, a leveled position of each pad conveyor may be required at all stages of use of a mega crane. Optionally, this sensitivity may apply when a high-speed winch pulls cargo on board a cargo vessel (e.g., at speed more than 2.4 km/h).

### Modified Cargo Vessel

As used herein, the term “cargo vessel” relates to a large ship designed to carry cargo containers.

According to some embodiments, a cargo vessel may be modified to include a series of travel pillars (heightened lashing bridges) along each side of each bay. According to some embodiments, the travel pillars may support horizontal cargo travel in each tier of containers and/or in each bay of the cargo vessel. According to some embodiments, the travel pillars height may reach the highest tier of cargo containers. According to some embodiments, the height of the travel pillars may decrease towards the bow of vessel to prevent obscuring the view from the bridge of the cargo vessel. According to some embodiments, the travel pillars may include on their sides wheel conveyors with hydraulic pistons. According to some embodiments, the hydraulic pistons may be associated with movable beams. Optionally, the movable beams may include travel wheels. According to some embodiments, the travel pillars on the port side and starboard sides of the cargo vessel may include one or more power winches at one or more distal and proximal points.

According to some embodiments, heightened lashing bridges may include a diagonal reinforcement at the sides of the cargo vessel since narrowness of the width in compare to the height.

According to some embodiments, systems for loading and/or loading of a cargo vessel may require the use of electricity on board the cargo vessel, e.g., one or more wheeled conveyors, one or more hydraulic pistons, one or more winches, one or more vessel mega cranes, one or more braking systems, one or more clutch systems, one or more automatic locks, etc. and/or any combination thereof. According to some embodiments, one or more high power electric cables may be deployed from the cargo vessel (e.g., with a sealed end) along with one or more mooring cables which may be connected to a port power source.

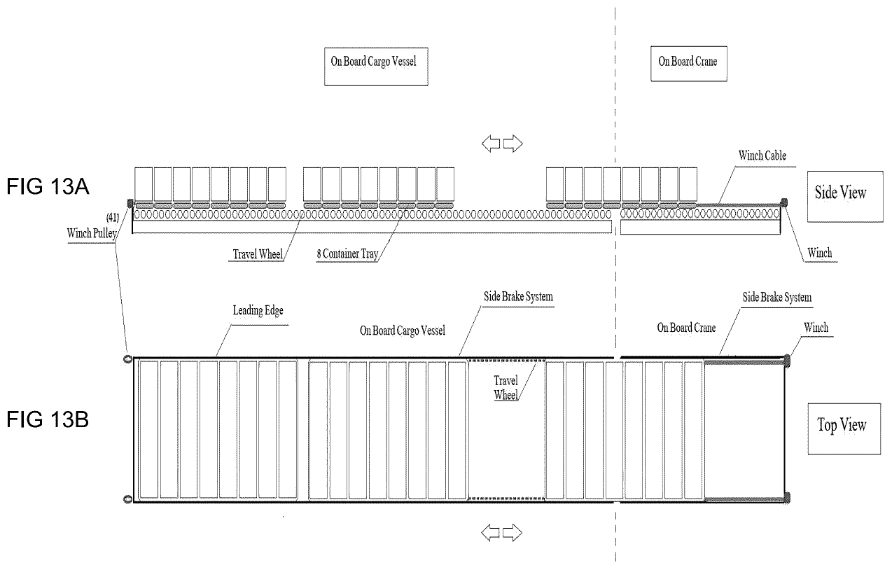

Reference is now made to FIGS. 13A-B, which are schematic diagrams of a side view and a top view, respectively, of containers transferred onto a cargo vessel and mega crane, in accordance with some embodiments. According to some embodiments, existing bay pillars tend to be low but may be modified and/or replaced by travel pillars which may be higher. Optionally, the travel pillars may be modified and/or added to reach the upper tier of cargo. Optionally, the travel pillars may be designed for heavy load capacity. According to some embodiments, travel pillars may be in the same position as the existing pillars. According to some embodiments, the travel pillars may include in each tier one or more side support wheels. Optionally, the side support wheels may maintain the containers in the required positions.

According to some embodiments, the winch systems designed to pull cargo may be used when an increase in the speed of cargo loading is required. According to some embodiments, one or more sets of power winches 41 may be located on the port and/or starboard sides of the cargo vessel in front and behind the bridge. According to some embodiments, one or more pairs of power winches may be located on the port side and/or starboard sides of the cargo vessel. Optionally, the winches may be at deck level and/or under deck, e.g., where machinery is current located. According to some embodiments, the winches may function parallel to the mega crane. According to some embodiments, the winch may connect and/or disconnect to a cable system in each bay and/or tier. According to some embodiments, the winch may connect to a row of linked containers automatically, remotely and/or manually.

According to some embodiments, on board a cargo vessel, a set of travel wheels and/or one or more winches may horizontally transfer a row of linked containers to a selected position (e.g., bay, tier, row, etc.). According to some embodiments, one or more hydraulic pistons may be attached to a movable travel beam. Optionally, the hydraulic pistons may lower a row of linked containers onto the corner castings of the cargo containers of the tier below and/or on the deck. According to some embodiments, on each bay and/or on each tier may be one or more container leading rails, which may act as funnels, which may facilitate a row of linked containers to enter a designated bay and/or tier. According to some embodiments, the container leading rail may be funnel shaped for ease of access.

According to some embodiments, travel pillars may be connected to each other by one or more horizontal and/or diagonal reinforcement beams. According to some embodiments, the reinforcement beams and/or travel pillars may include one or more side support wheels. According to some embodiments, the side support wheels may serve as bumpers and/or buffers between the cargo containers and/or the travel pillars and/or the reinforcement beams.

According to some embodiments, the horizontal movable beams may include a set of travel wheels (e.g., wheeled conveyor). According to some embodiments, travel pillars, horizontal movable beams and/or travel wheels may not interrupt crew work. According to some embodiments, travel wheels may include electric motors and/or brake capabilities. According to some embodiments, a winch may be used in conjunction with the wheel conveyors (e.g., travel wheels) as a secondary and/or backup system. According to some embodiments, use of a wheel conveyor and/or winches may facilitate horizontal movement of containers. According to some embodiments, one or more power winches may move a row of linked containers onboard the vessel.

For example, FIGS. 13A-B show schematic diagrams of a cargo vessel tier (left of the dashed line) with two rows of linked containers on board the cargo vessel, and a third row of linked containers being unloaded from the cargo vessel to the mega crane (right of the dashed line) by being pulled from the cargo vessel to a pad conveyor by winches over travel wheels and/or by the wheel conveyor on the cargo vessel and/or on the mega crane pad conveyor.

According to some embodiments, on the side of the cargo vessel may be a winch pulley 41. According to some embodiments, a winch pulley may be located at the distal side of each tier. According to some embodiments, a pulley may deliver pulling power from a deck and/or under deck winch to a required tier. According to some embodiments, at the end of pad conveyor distal to the cargo vessel may be one or more winches configured for pulling cargo off a cargo vessel.

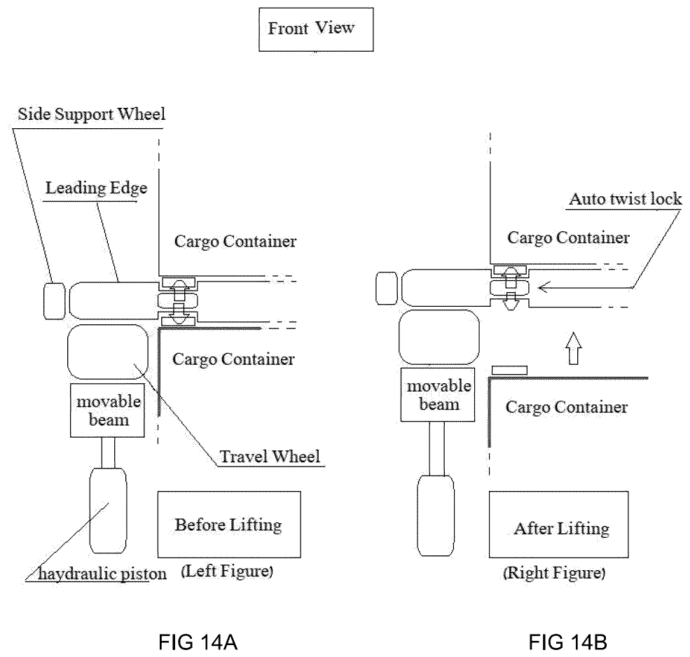

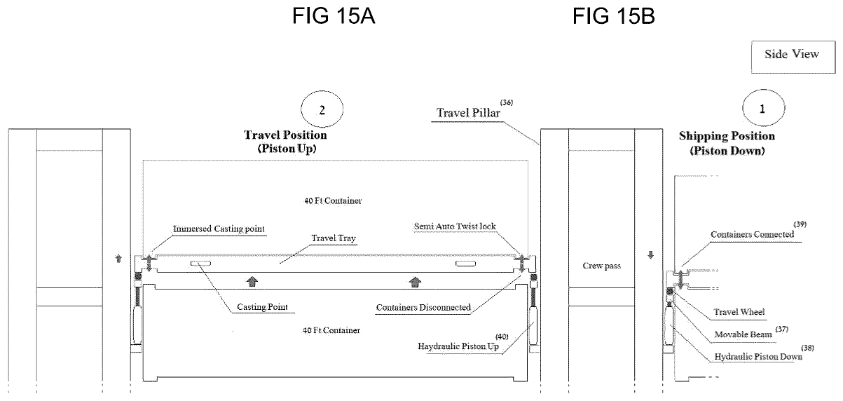

Reference is now made to FIGS. 14A-B and FIG. 15A-B, which are schematic diagram of a mechanism for hydraulic lifting and locking containers on a cargo vessel in accordance with some embodiments. According to some embodiments, on board a cargo vessel may be movable beams, which may move up and/or down when unloading and/or loading cargo, e.g., using one or more hydraulic pistons located on each travel pillar sides at each tier at each bay. In FIG. 14A, a container on a travel tray may be lowered to the top of an existing tier of containers, and connected to each other, e.g., by automatic twist locks. In FIG. 14B, an upper travel tray may be disconnected from a container on a lower tier.

According to some embodiments, in order to fit a cargo vessel to support horizontal traveling of cargo containers, series of travel pillars may be located between the cargo bays of the vessel. Optionally, crew may pass through and/or between travel pillars. According to some embodiments, travel pillars may be re-fitted to increase their height and/or strength, e.g., to reach the upper tier of cargo and/or may be designed for heavy load capacity.

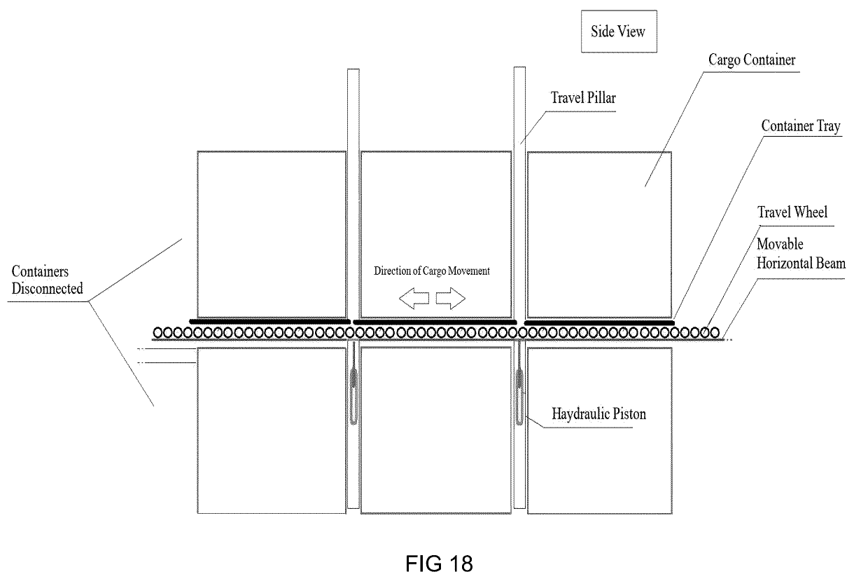

According to some embodiments, travel pillars 36 may be equipped with one or more movable beams 37, one or more travel wheels, and/or one or more hydraulic pistons 38 (e.g., FIGS. 15A-B). According to some embodiments, the travel pillars may facilitate horizontal movement of one or more travel trays on top of one or more movable beams which may include travel wheels. For example, in the shipping position (e.g., FIG. 15B and FIGS. 14A-B), the containers are lowered on top of the containers in the tier below and the hydraulic pistons are retracted, the movable beam is down, and the tiers of containers are connected 39. In the loading/unloading position (e.g., FIG. 15A and FIG. 18) the containers may be raised by the hydraulic pistons before loading and/or unloading cargo. The containers may be in a higher position, hydraulic pistons may be extended 40, the movable beam may be up, and containers may be disconnected ready for movement.

According to some embodiments, one or more hydraulic pistons may be attached to one or more movable beams. According to some embodiments, the hydraulic pistons may raise and/or lower the horizontal movable beams. According to some embodiments, raising the hydraulic pistons and/or horizontal movable beams may allow horizontal movement of the containers, e.g., during loading and/or unloading. According to some embodiments, each movable beam may be attached to multiple hydraulic pistons (e.g., 2, 3, 4, 5, 6, 7, 8, 9, 10, etc.). Optionally, each movable travel beam may connect several travel pillars to enable raising of multiple containers (e.g., 10 hydraulic pistons—5 on each side—may be connected to 4 containers which may be raised and/or lowered as a set). Optionally, multiple hydraulic pistons may raise and/or lower a set of between 1 and 24 containers simultaneously. Optionally, before raising and/or lowering a set of containers, locks between travel tray rows edges may be disconnected.

According to some embodiments, lowering the hydraulic pistons and/or the movable beams may lower the containers onto the tops of the containers of the tier below and/or to the deck level. According to some embodiments, the containers in each tier be the same height (e.g., combining the use of high cube containers may not be possible with standard containers in the same tier).

According to some embodiments, one or more bays may not include one or more elements of the Mega STS system as described herein, preferably at the front of the vessel. Optionally, this may provide central planners with more flexibility during planning the loading and/or unloading containers, e.g., high cube containers, various other constraints, etc.

According to some embodiments, lowering the containers onto the tops of the containers of the tier below and/or on vessel's deck may facilitate locking the two tiers to each other at casting points, e.g., by automatic twist locks, etc. According to some embodiments, locking the tiers of containers to each other may provide fixation of containers to vessel's body during shipping. According to some embodiments, locking the tiers of containers to each other (vertically and/or horizontally) may reduce and/or remove the need for lashing and/or unlashing the containers. According to some embodiments, locking the tiers of containers to each other may reduce the amount of time required to load and/or unload containers from a cargo vessel. According to some embodiments, locking the tiers of containers to each other may be performed automatically, remotely and/or manually. According to some embodiments, if extra securing is required, lashing may be facilitated at specific lashing casting points on the travel tray e.g., on the travel tray sides.

For example, a first set of 8 containers may reach the upper tier of containers already loaded onboard the cargo vessel (second set). The first set of containers may travel on a set of travel wheels with electric motors on the movable beams connected to hydraulic pistons mounted on the travel pillars by attachment to travel trays connected to the containers. When the required destination of each container of the first set of containers is reached, the containers may be stopped, and a set of hydraulic pistons may lower the containers on to the second set of containers of the tier below. Optionally, the first and second sets of containers may be locked together using electric automatic twist locks.

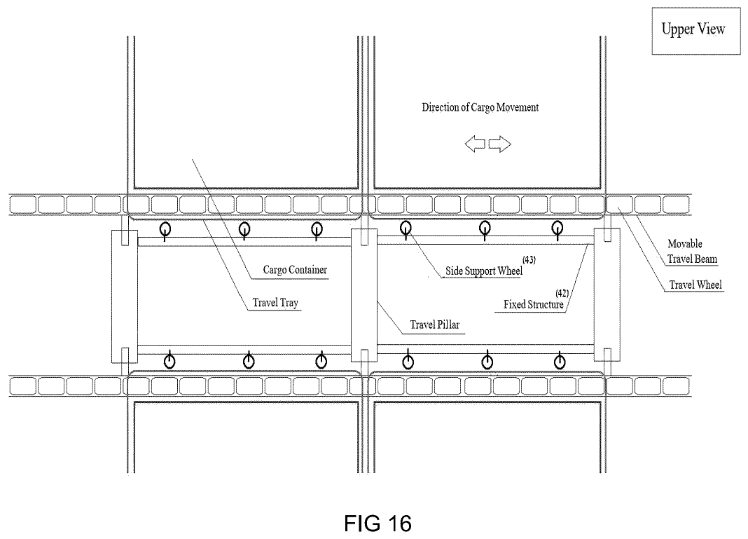

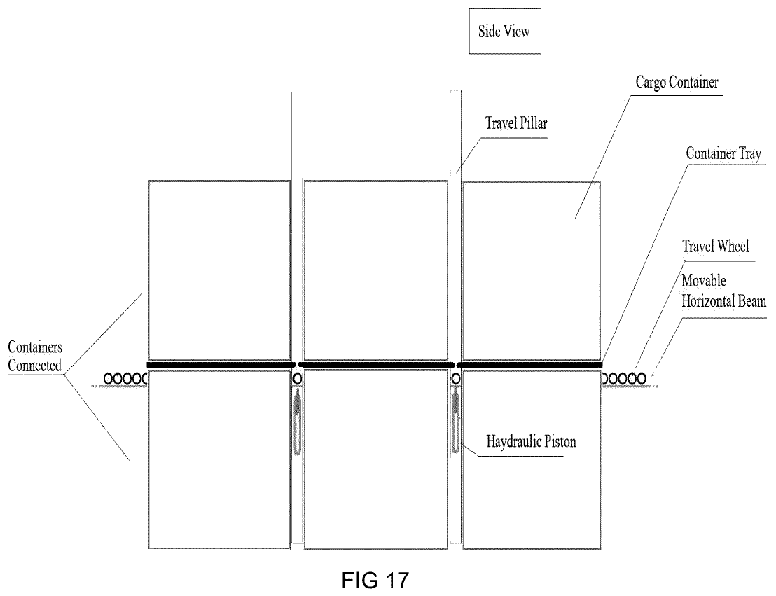

Reference is now made to FIGS. 16, 17 and 18, which are schematic diagrams of a top view, side view with hydraulic pistons raised, and side view with hydraulic pistons lowered of containers on a cargo vessel, in accordance with some embodiments. According to some embodiments, travel pillars may be connected to each other by fixed horizonal reinforcement beams 42, which may connect travel pillars horizontally (e.g., FIG. 16). According to some embodiments, at the sides of each pillar two hydraulic pistons may be located (e.g., one on each side), According to some embodiments, the movable beam may be raised and/or lowered by hydraulic pistons located on travel pillars. For example, the movable beam length may be about 10 m, and may support 4 containers with 5 hydraulic pistons (e.g., 2 movable beams, on opposite sides of the bay with 8 hydraulic pistons to raise and/or lower cargo). According to some embodiments, side support wheels 43 may centralize and/or secure rows of travel trays. Optionally, at the connections between two movable beams may be a set of two hydraulic pistons on each pillar on each side (e.g., total of 4 pistons).

According to some embodiments, travel pillars may be horizontal and vertically fixed. According to some embodiments, travel pillars may not interrupt crew work e.g., the travel pillars may be hollow in the middle to facilitate crew passage. According to some embodiments, hydraulic pistons may be attached to the sides of the travel pillars facing inwards towards the cargo bay. According to some embodiments, travel wheels may be attached to the movable beams. According to some embodiments, the travel wheels may have between about 5 cm to about 10 cm, between about 10 cm to about 15 cm, or between about 15 cm to about 25 cm between each other. Each possibility is a separate embodiment. Preferably, the travel wheels may have a distance of about 10 cm between each other. According to some embodiments, travel wheels may include electric motors and/or brake capabilities, thereby allowing horizontal movement of cargo containers on board a cargo vessel. According to some embodiments, winches may move rows of linked containers onboard the cargo vessel faster.

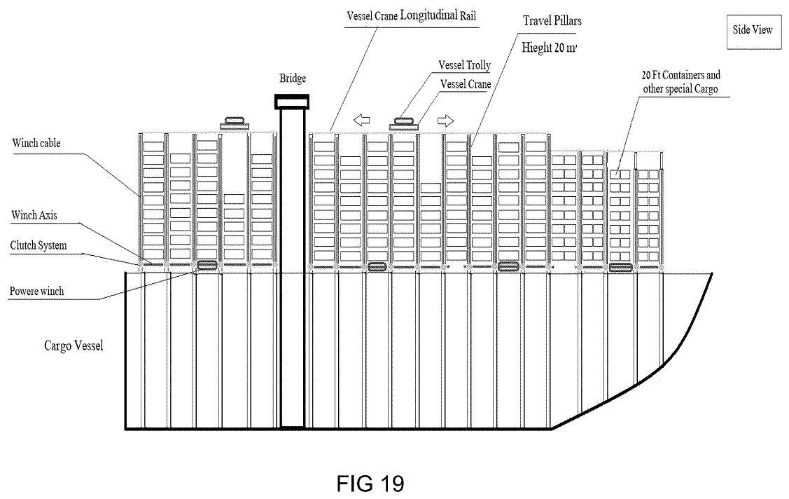

Reference is now made to FIG. 19, which is a schematic diagram of a side view of a cargo vessel with winch system, in accordance with some embodiments. According to some embodiments, on the cargo vessel sides at deck level and/or under deck where machinery may be located, there may be one or more winches (e.g., power winches) with pulling capacity of up to 250 tons (e.g., the weight of an 8-container row). According to some embodiments, the winches may be placed along the sides of the deck. According to some embodiments, each winch may be connected to a gear box, which may include rotating axis from each of its sides. According to some embodiments, each axis may be connected to several bays with a clutch system to allow selection of a specific bay and/or specific tier. According to some embodiments, bay gears may be connected to a set of cables which may be connected to each tier, as required. According to some embodiments, at a specific tier the cable may curve up to 90° over one or more pulleys which may be configured to convert the direction of pull from vertical to horizontal across the width of the vessel. According to some embodiments, the cables may include a hook at their distal end. According to some embodiments, the hook may be attached to a travel tray prior to pulling the travel tray on board the cargo vessel.

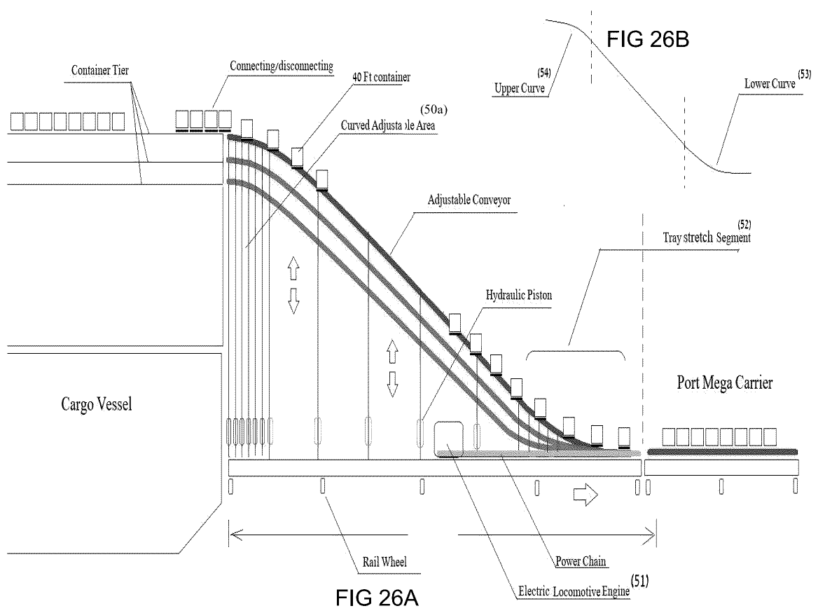

According to some embodiments, the winch system may include one or more sets of bay cables, bay gears and/or bay tier pulleys. Additionally, and/or alternatively, according to some embodiments, a slope conveyor (e.g., FIGS. 26A-B) system may be used. According to some embodiments, a slope conveyor may push and/or pull cargo to a desired location on board a cargo vessel.

According to some embodiments, cargo may be loaded and/or unloaded onto the deck and/or below the deck of a cargo vessel. According to some embodiments, loading and/or unloading cargo using the mega STS system may take place alongside existing port machinery and/or systems.

### Vessel Mega Crane (e.g., Vessel Crane—VC)

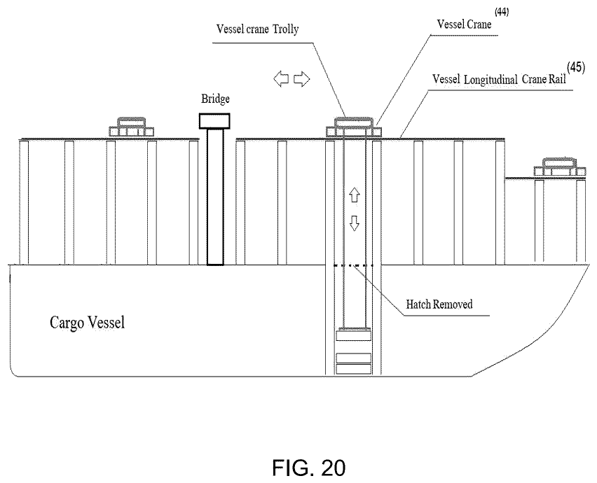

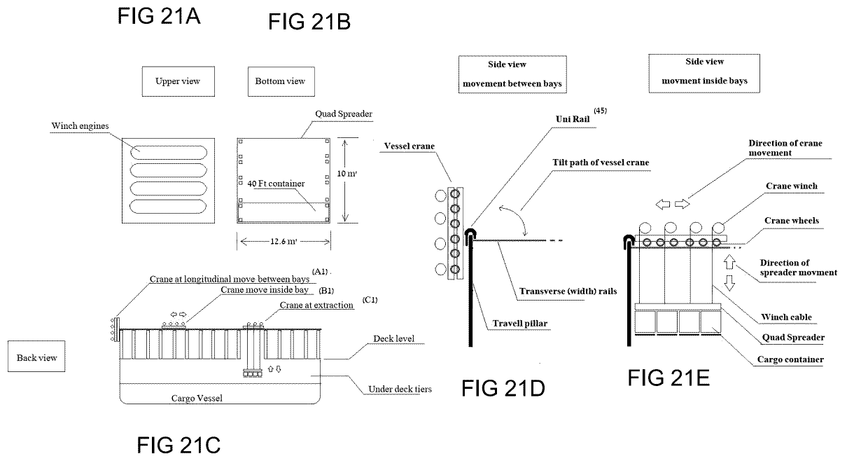

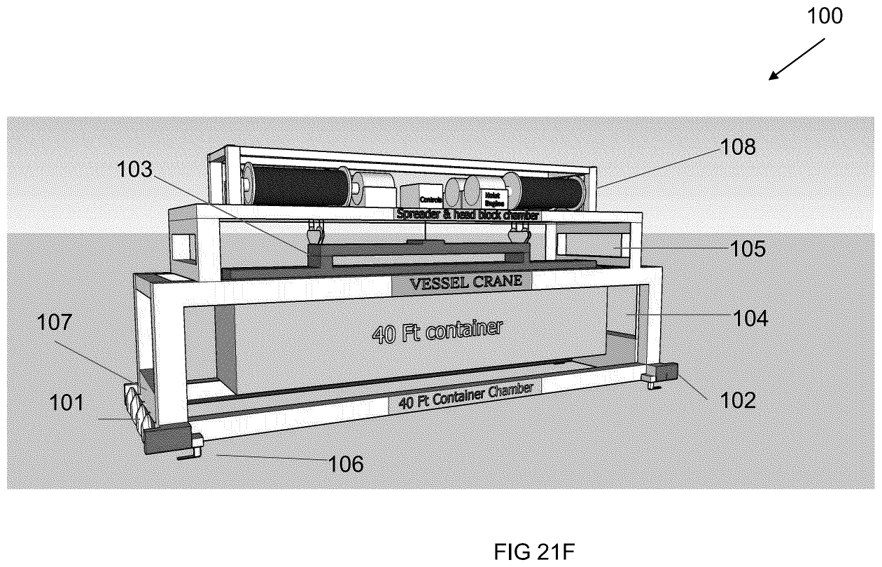

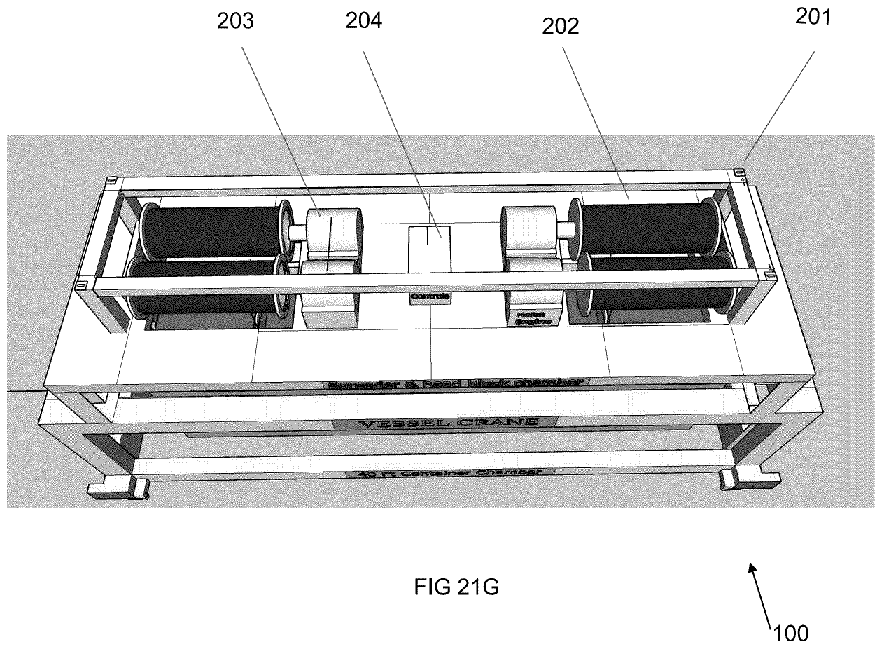

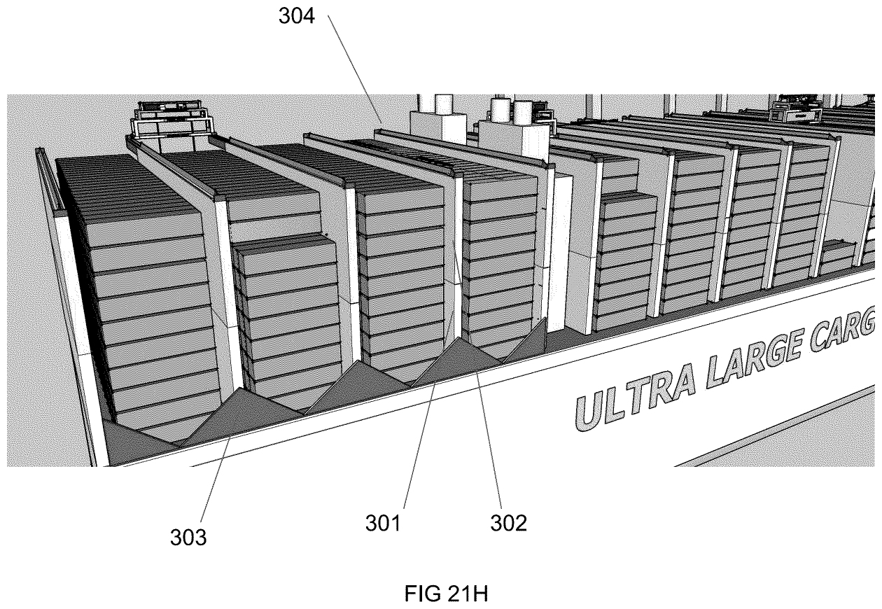

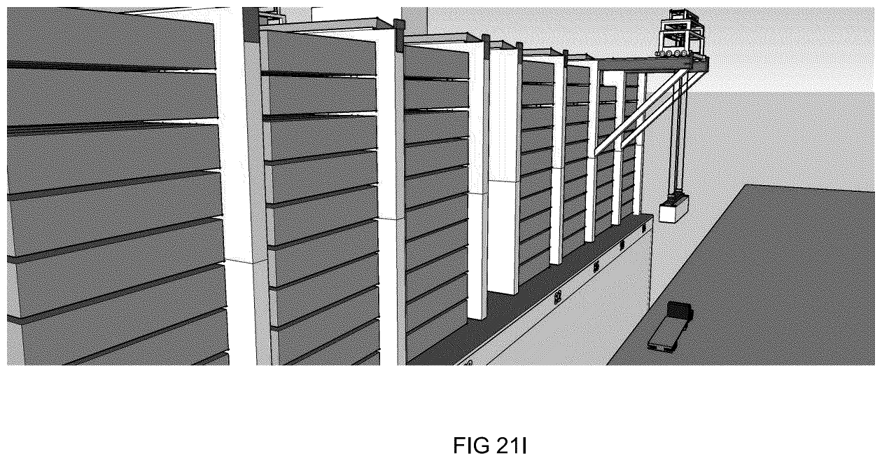

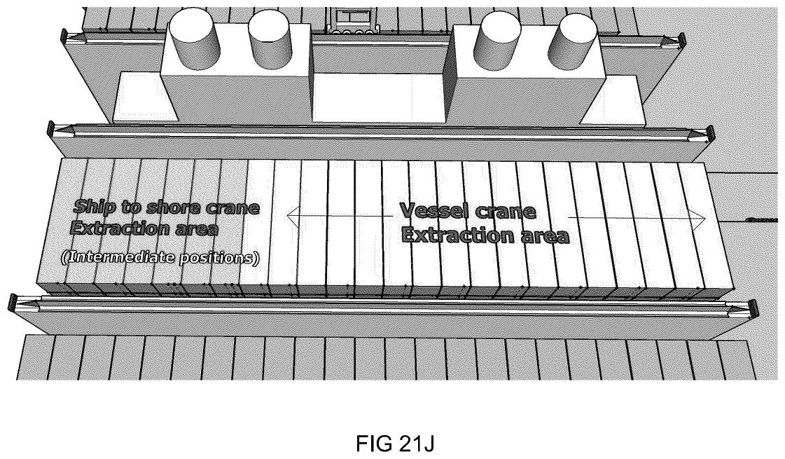

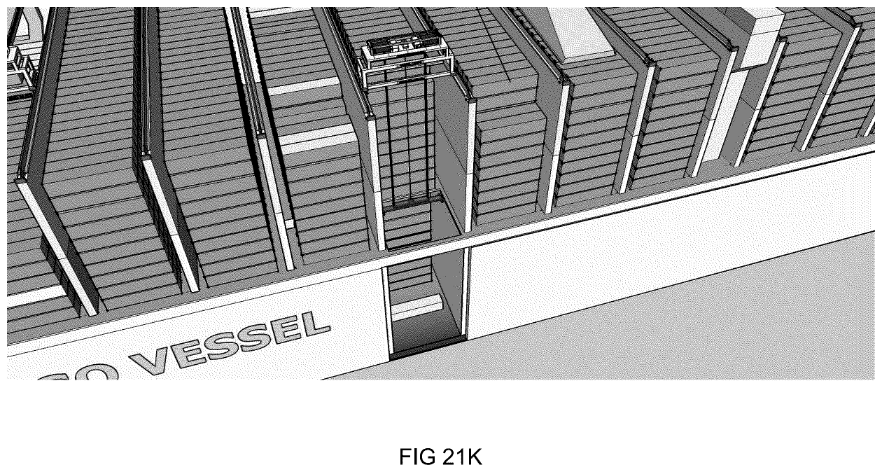

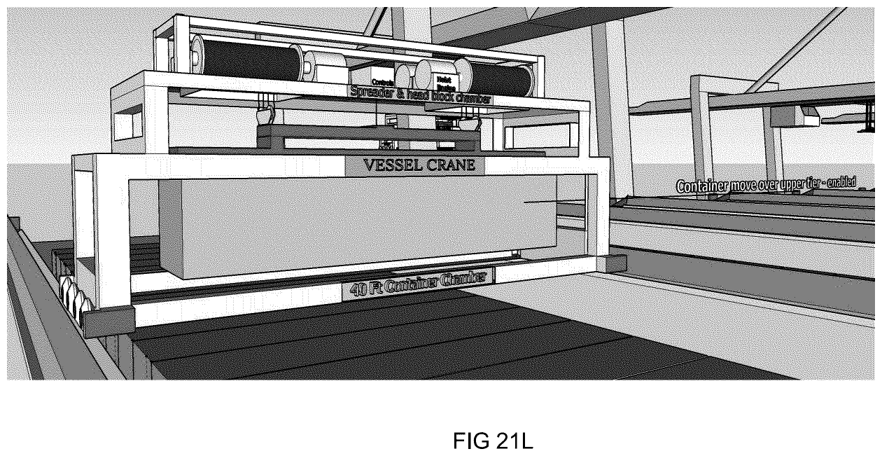

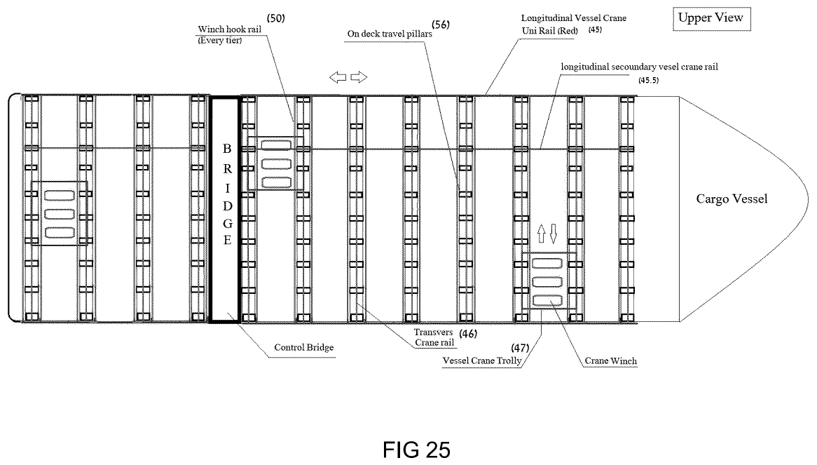

Reference is now made to FIG. 20 and FIGS. 21A-E, which are schematic diagrams of some views of a vessel mega crane (hereinafter called: “vessel crane”), in accordance with some embodiments. According to some embodiments, a cargo vessel may include one or more vessel cranes. According to some embodiments, under deck container extraction may be performed using a vessel crane 44. According to some embodiments, vessel cranes may travel along one or more longitudinal side uni-rail 45. Additionally, and/or alternatively, vessel cranes may travel along the length of the vessel using secondary longitudinal vessel crane rail (45.5, FIG. 25). According to some embodiments, even if longitudinal and transvers rails intersect, electric power may be supplied with isolation. Optionally, the secondary rail may be foldable so as not to interfere with STS crane operation (e.g., FIG. 25). According to some embodiments, vessel cranes may move (A1) on top of cargo vessel travel pillars (heightened lashing bridges) 56, by transverse upper rails associated with each cargo vessel bay (B1), and/or up and down for cargo extraction and deposition below deck (C1) (e.g., FIG. 21C). According to some embodiments, a vessel crane may move only when a cargo vessel is anchored and/or docked (e.g., FIG. 21C and FIG. 21E). According to some embodiments, when the cargo vessel is underway, the vessel crane may be locked horizontally on transverse to the rails and locked to a uni-rail trolly (e.g., FIG. 21D). According to some embodiments, to transfer cargo, the vessel crane may lie horizontally on transverse rails and may be disconnected from the uni-rail (e.g., FIG. 21C and FIG. 21E). According to some embodiments, vessel cranes may operate in each segment on the cargo vessel. According to some embodiments, vessel cranes may be used interchangeably. According to some embodiments, vessel cranes may be located behind the bridge, in front of the bridge and/or for lower tiers at the front of the cargo vessel. According to some embodiments, a vessel crane in each bay may expedite loading and/or unloading capacity.

According to some embodiments, the longitudinal rails may run along the terminal side and/or starboard side of the cargo vessel. According to some embodiments, uni-rails may allow longitudinal travel of the vessel crane on the cargo vessel. According to some embodiments, a vessel crane may travel along a uni-rail and stop at a specific bay of the cargo vessel. According to some embodiments, one or more hydraulic pistons may pivot the vessel crane 90° towards the deck, i.e., from vertical to horizontal. According to some embodiments, vessel cranes may then move along the width of the vessel on one or more transvers rails, preferably two. According to some embodiments, the vessel crane may attach to one or more containers in one or more bays of the cargo vessel using a quad spreader (e.g., FIG. 21B/24). According to some embodiments, the vessel crane may include one or more winches and winch engines on the upper surface of a trolley (e.g., FIG. 21A/24). According to some embodiments, the winches may be connected to the quad spreader by one or more cables along the edges of the quad spreader. Optionally, when in stand-by position and/or prior to attachment to one or more cargo containers, a quad spreader may be located close to the vessel crane trolley.

According to some embodiments, the vessel cranes may extract one or more containers after the hatch in the cargo vessel deck is removed by a vessel crane in the same bay. According to some embodiments, the vessel cranes may raise and/or lower containers attached to the quad spreader to and/or from a storage area below the deck of a cargo vessel.

According to some embodiments, a vessel crane may be operated manually, automatically and/or remotely.

According to some embodiments, the ability of the quad spreader to extract up to 4 containers at a time may stem from riding on rails without boom moment as used with a standard STS crane.

According to some embodiments, the vessel crane may be a terminal machinery that uploaded by the STS crane on the upper rails of the cargo vessel before loading and/or unloading of cargo containers and/or also be able to be mounted on the vessel al all time even during voyage at sea.

According to some embodiments, the vessel crane may be used as relocating cargo containers from distal end side on the cargo vessel (to the terminal) to proximal side on the cargo vessel (to the terminal) and place them on intermediate positions. As another task can relocate cargo while vessel at pre berth or calm voyage at sea.

According to some embodiments, intermediate positions are the 6 and between 8 rows closest to the terminal (preferrable 6) onboard the vessel. (e.g., FIG. 21J) The STS Crane lifts containers only to intermediate positions of every bay and pics containers to be unloaded only from these positions.

According to some embodiments, when moving a container from distal side to terminal (onboard the vessel) to proximal side and placing it on top other container beneath it (at the intermediate position), the upper container may be locked in cases there are twist locks attached the bottom of the moved container. To prevent container lock to the beneath container at these positions anti-lock prevention system will be applied.

According to some embodiments, a specific vehicle may bring the vessel crane under the STS' crane loading area as per central's planners load/unload plan.

According to some embodiments, when load/unload tasks end, the vessel crane may be removed from the cargo vessel upper rails to terminal ground by the STS crane.

According to some embodiments, the vessel crane can be transferred to from bay X to bay X+c by the STS crane (VC bay re-location).

According to some embodiments, the vessel crane comprises from a trolly spans on top of 2 upper rails with span of 13 or 14 or 15 or 16 meters. According to some embodiments, Trolly moves on wheels and electric engines who powered by negative charge placed on top or side or under the upper rails (heightened lashing bridges) (e.g., FIG. 21F).

Reference is now made to FIG. 21F, which schematically shows a side view of a container vessel crane 100. According to some embodiments, a 40 Ft container (FEU) or 2 of 20 Ft containers (TEU's) can be embedded inside the trolly's lower chamber that called the container chamber 104.

According to some embodiments, on top of the container chamber 104 located the spreader and head block chamber 105 for securing the spreader 103. On top of this chamber located the machine room 108. The machine room has the dimensions of 40 ft container but can be in other dimensions as 20 FT container, on top of machine room located 4 casting connections same as 40 ft container.

According to some embodiments, each side of the VC's trolly (104 and 105) equipped with an engine and gear 107 for reliable movement, and wheels 101. At the front and rear sides of the VC's trolly located bumpers 102 responsible to ease stop at ends of the rails mounted on the lashing bridges.

According to some embodiments, under the VC's trolly located rail lock system 106 ensuring safety operation and securing of the trolly to the rail.

Reference is now made to FIG. 21G, which schematically shows a side view of container vessel crane 100. According to some embodiments, on top of the vessel crane there is 4 corner castings 201, same as on 20 FT and/or 40 FT cargo container (preferable as on 40 FT container) or other suitable connection. According to some embodiments, standard casting connection used to allow STS crane's spreader to attach to the vessel crane before moving it.

According to some embodiments, the vessel crane has 1 or 2 or 4 hoist engines 203 with capability to carry the load up to dual spreader and dual head block and 1 or 2 of 40 ft cargo containers. According to some embodiments, the VC has 4 drums 202 capable each to roll about 100 m or more of hoisting cable.

According to some embodiments, the VC has controls and communication components 204, allow efficient operation. Communication allows remote access for human and/or autonomous interface.

According to some embodiments the vessel crane can carry more than 2 of 40 ft cargo containers and/or can move 45 Ft or any other type of containers. According to some embodiments, the width of the vessel crane's trolly can be from width single cargo container or wider.

According to some embodiments, since spreader hanged under the vessel crane can sway then when loaded/unloaded to cargo vessel needs to be secured to prevent sway of the spreader. Also, an anti-sway reeving system installed to prevent spreader sway while trolly at movement.

Reference is now made to FIG. 21H, which schematically shows a side view of cargo vessel with modified lashing bridges. According to some embodiments, (e.g., FIG. 21H) current lashing bridges 301 on big container vessels stand up to tier 5 of containers on board the vessel's deck, the modification requires heightened lashing bridges up to highest tier of container optional (heightened lashing bridges 302) on top these there are rails 304 allowing the movement of the vessel crane. According to some embodiments, since travel walls (heightened lashing bridges 302) may be required on board the cargo vessel and may be over 10^{th} tier and the width of the travel walls may be about 1.3 meters so diagonal reinforcement 303 at the bases of the heightened lashing bridges may be required.

According to some embodiments, on top of the heightened lashing bridges there are rails with opposite shape to VC trolley wheels. Every set of rails include 1 vessel crane rail then a triangle buffer and second vessel crane rail. 2 Triangle buffers creates funnel guidance and assist the STS operator to place VC efficiently on top of his rails.

Reference is now made to FIG. 21I, which schematically shows a cargo vessel with horizontally extended rails and modified lashing bridges. According to some embodiments, on top side of every heightened lashing bridge, there are extracting rails (e.g., FIG. 21I) allowing the VC to be outreached of the vessel parameters. This capability enables loading/unloading of containers directly from terminal ground.

Reference is now made to FIG. 21J, which schematically shows a top view of the cargo vessel of FIG. 21H, the division of cargo extraction areas between the STS crane and the container vessel crane. According to some embodiments, by executing this task, the vessel crane allows the STS crane to move cargo by half route. Also load and unload at same time possible since the vessel crane can get cargo from intermediate positions (e.g., FIG. 21J) to be placed on destination spot on board the cargo vessel. Reference is now made to FIG. 21K, which schematically shows a top view of the cargo vessel of FIG. 21H, and an underdeck cargo extraction. According to some embodiments, the vessel crane is able to extract cargo containers from underdeck tiers (e.g., FIG. 21K). According to some embodiments, cable drums allow vertical movement (up and down) of the cargo container.

Reference is now made to FIG. 21L, which schematically shows the container vessel crane of FIG. 21F moving over upper tier (of on-board cargo containers). According to some embodiments, to allow relocation of containers over the highest tier of containers on board the cargo vessel the container may enter inside the heightened body of the vessels crane trolly. (e.g., FIG. 21L).

According to some embodiments, to prevent collision between the STS crane to the vessel crane that work in the same bay on board the cargo vessel no route intersection be allowed unless safety measures taken.

According to some embodiments, the vessel crane can relocate hatch covers on board the cargo vessel.

According to some embodiments, each STS can be assisted by 1 or more vessel cranes, preferably 2 or more simultaneously. This requires the STS to move from bay X to Bay X+1 and return every Y container that loaded/unloaded. In this situation while STS work in bay X with the assist of first vessel crane, the second vessel crane delivers more containers to closest positions onboard the cargo vessel to the terminal at next bay.

According to some embodiments, the VC can be a permanent equipment of the vessel even at ocean voyage. In this case all VC be transferred by the STS to 1 bay before vessel main funnel top area and or behind bridge area. All VC Be lashed before voyage and secured. When arriving at the next port, the STS crane will relocate them to all bays.

According to some embodiments, the ability of the quad spreader to extract 4 containers at a time may stems from riding on rails without boom moment as used with a standard STS crane.

Reference is now made to FIGS. 22A-C, which are schematic diagrams of side view and front views, respectively, of a contracting travel tray in accordance with some embodiments. According to some embodiments, to minimize the length of a travel tray, a contracting travel tray may be used under deck. According to some embodiments, a contracting travel tray may be configured for reversible retraction of one or more leading edges or tongues 54 (e.g., FIG. 22B and FIG. 22C). According to some embodiments, a contracting travel tray may be used in its extended and/or retracted configuration. According to some embodiments, a contacting travel tray may include one or more immersed casting points in addition to one or more side lashing casting points. According to some embodiments, contracting travel tray tongues may be operated manually, automatically and/or remotely. According to some embodiments, a travel tray may be used in its extended and/or retracted configuration. According to some embodiments, electricity may be supplied to the travel tray to move between locked, unlocked, extended and/or retracted configurations through electrical contacts in the travel wheels (e.g., left side of the bay may provide negative charge and right side of the bay may provide positive charge). Optionally, remote activation may facilitate contraction of the travel tray when lowered below deck, and/or expansion of the travel tray on extraction of the travel tray above deck level. Also see the description of the travel tray with respect to FIG. 2 and FIGS. 3A-C.

For example, a contracting travel tray may contract to about 12.2 m in length (e.g., 40 ft container standard length) by contraction of both tongues, and after expansion of the tongues, a contracting travel tray may expand to about 12.6 m in length.

Reference is now made to FIGS. 23A-C, which are schematic diagrams of a cut away perspective view of a contracting travel tray in accordance with some embodiments. According to some embodiments, a contracting travel tray may have at least two configurations. Optionally, the contracting travel tray may move from one configuration to another configuration reversibly. According to some embodiments, a first configuration may be an extended configuration (A), in which one or more retractable side tongues may be extended and be used on deck. Optionally, the retractable side tongue may be extracted using electric engine inside the travel tray with rechargeable batteries and may work as a backup power source and/or in case cargo extraction to first tier on board vessel (e.g., when no electricity is available from the vessel crane and/or prior to placing containers on a wheel conveyor, actions may optionally be performed manually). Optionally, charging of the batteries may take place when the travel tray is placed on a wheel conveyor. Optionally, one or more sensors in the travel tray may detect that a tier has been reached and operate tongue extraction accordingly. Optionally, after tongue extraction, a vessel crane may place a container on the wheel conveyor. Optionally, one or more extracting pins may be used to extract and/or retract the tongue.

According to some embodiments, a second configuration may be a retracted configuration, in which one or more retractable side tongues may be retracted within the body of the travel tray.

According to some embodiments, the travel tray may include one or more immersed casting connection points (B), e.g., 4 and/or 8 points. According to some embodiments, the travel tray may include one or more connection points along one or more long edges, i.e., along the length of the travel tray (e.g., longitudinal axis), preferably 4 connection points on each side. Optionally, the connection points along the first side (e.g., the distal edge) may be female connection points. Optionally, the connection points along a second side (proximal edge) may be male connection points. Optionally, the male connection points may be withdrawn into the travel tray. Optionally, the male connection points may be extracted for connection to a second travel tray. According to some embodiments, male connecting pins may include a pointed edge. Optionally, the male connection points of a first travel tray may attach to the female connection points of a second travel tray, etc. According to some embodiments, travel trays may be connected to additional travel trays at one or more casting connection points.

According to some embodiments, locking each travel tray to the next travel tray may be made by an inner tray trapeze latch lock system (C). Optionally, the trapeze shape may minimize the gap between travel trays. Optionally, the male connecting pin may be horizontally flexible in order to prevent shear stress during horizontal movement of a row of linked containers.

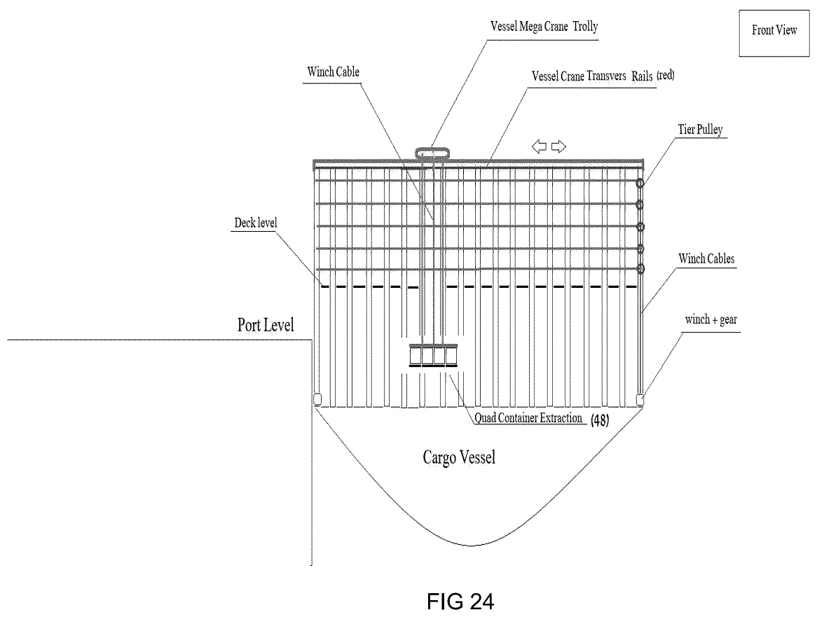

Reference is now made to FIG. 24, which is a schematic diagram of a front view of a moored cargo vessel showing a vessel crane, in accordance with some embodiments. According to some embodiments, extraction of containers from below deck storage may be performed by a vessel crane. According to some embodiments, the process of unloading cargo from below deck storage of a cargo vessel may include moving a vessel crane over the rail to a specific bay, rotating the vessel crane to a horizontal position using hydraulic pistons, such that the vessel crane trolly travels along two transverse rails. According to some embodiments, the trolley may then travel along the transverse (width) rails until the required position in the bay is reached. According to some embodiments, the trolley may be locked in the required position in the bay. According to some embodiments, a quad spreader 48 may be lowered from the trolley to pick up one or more containers (e.g., 2 containers, 4 containers, etc.). According to some embodiments, the attached containers may be lifted out of the below deck storage without movement of the trolly. According to some embodiments, once the containers reach the required above deck height, the travel tray expands to max length, and may be placed on travel wheels for on deck storage and/or unloading. According to some embodiments, the travel trays of the extracted containers may be connected to each other and/or to the travel trays of containers already present in the bay. According to some embodiments, this process may be revered for loading cargo into below deck storage.

Reference is now made to FIG. 25, which is a schematic diagram of a top view of a cargo vessel with vessel cranes, in accordance with some embodiments. According to some embodiments, a cargo vessel may include longitudinal vessel crane uni-rail 45 (side rails (red)) and transvers (width) rails 46 (turquoise), which may facilitate movement of a vessel crane along the length of the cargo vessel (e.g., from stem to stern), and along the width of the cargo vessel (e.g., from port side to starboard side), respectively. In some embodiments, vessel cranes may travel along the length of the vessel using a longitudinal secondary vessel crane rail (45.5). According to some embodiments, a crane trolly 47 may include power winches with vertical lifting capacity up to about 100 tons, up to about 120 tons, up to about 150 tons, up to 250 tons, or more. Each possibility is a separate embodiment. Preferably, a crane trolly may include power winches with vertical lifting capacity up to about 120 tons. According to some embodiments, winch hook rails 50 may be attached to on deck travel pillars 56 at each tier. According to some embodiments, the winch hook rails may be configured to facilitate attachment and/or detachment of one or more rows of linked containers.

### Mega Slope

Reference is now made to FIGS. 26A-B, which are schematic diagrams of a side view of a mega slope conveyor, in accordance with some embodiments. According to some embodiments, a mega slope conveyer may be used as an alternative to a mega crane. According to some embodiments, a mega slope may run on train tracks parallel to the waterfront e.g., 5 rail tracks.

According to some embodiments, the mega slope may be raised as high as the highest tier of cargo on board the cargo vessel. According to some embodiments, the mega slope may have a height of between about 20 m to about 30 m, between about 30 m to about 40 m, between about 40 m to about 50 m, between about 50 m to about 60 m, or between about 60 m to about 75 m, preferably 50 m. Each possibility is a separate embodiment.

According to some embodiments, the mega slope may have a width of between about 10 m to about 15 m, between about 15 m to about 20 m, or between about 20 m to about 30 m, preferably about 16 m. Each possibility is a separate embodiment.

According to some embodiments, the mega slope may have a length of between about 40 m to about 50 m, between about 50 m to about 60 m, between about 60 m to about 70 m, or between about 70 m to about 100 m. Each possibility is a separate embodiment. Preferably, the mega slope may have a length of about 60 m.

According to some embodiments, the mega slope may have a slope incline angle of less than 60°, less than about 50°, less than about 40°, or less than about 30°, preferably about 40°. Each possibility is a separate embodiment. According to some embodiments, the mega slope may include adjustable upper and/or lower curves, 54 and/or 53, respectively. According to some embodiments, the adjustable upper and/or lower curves, 54 and/or 53, respectively, may be adjusted by a set of hydraulic pistons called curved adjustable areas 50a and angle structure adjustment may be adjusted by hydraulic pistons, thereby facilitating cargo vessel tier height adjustment.

According to some embodiments, since some cargo vessels may be at different distances and/or heights from the base of the mega slope (e.g., because their shape, etc.), the mega slope may be capable of extending a conveyor to the cargo vessel in order to close the gap. Optionally, the mega crane may adjust for cargo vessel height and/or distance from the moorings.

According to some embodiments, the mega slope may include two or more chain conveyors, e.g., 3 chain conveyors, 5 chain conveyors, etc. According to some embodiments, the chain conveyors may be able to load a row of 8 separated containers along the chain conveyor, and/or unload one or more rows of linked containers from a cargo vessel.

According to some embodiments, slope conveyor may have one or more electric engines (e.g., similar to an electric locomotive) 51 with suitable capacity. According to some embodiments, a slope conveyor may push a row of separated containers onboard the cargo vessel until an entire tier has been completely loaded. According to some embodiments, the slope conveyor may include a brake mechanism configured to slow cargo on unloading. According to some embodiments, when using a slope conveyor all connections between travel trays may be disconnected automatically before transfer to and/or from a mega carrier to a mega slope. According to some embodiments, the travel trays may be separated from each other prior to passing over a stretch segment 52 (lower curve) of the mega slope.

Advantageously, according to some embodiments, using a mega slope to lift cargo does not require the mega carrier have two winches on the side close to vessel, since the slope conveyor pulls cargo from the mega carrier and pushes cargo up onboard the cargo vessel. Additionally, according to some embodiments, there may be no need for side power winches system on the sides of the cargo vessel, and/or no need for gears and/or pulleys and/or cables system on board the cargo vessel since the mega slope may pulls and/or push cargo on to and/or off the cargo vessel.

According to some embodiments, a cargo container on a travel tray may be attached to a wheeled conveyor by extracting a pin on a leading edge of the travel tray. Optionally, the extracting pin may be attached to a parallel rail and/or a parallel conveyor.

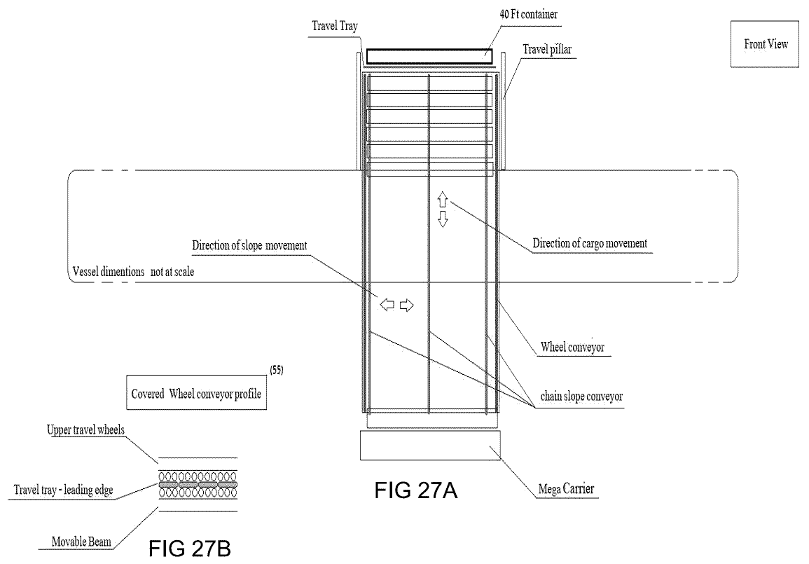

Reference is now made to FIGS. 27A-B, which are schematic diagrams of a front view and side view, respectively of a mega slope conveyor, in accordance with some embodiments. According to some embodiments, when using a mega slope upper travel wheels may be used (e.g., covered wheel conveyor profile 55) in order to prevent convexity of cargo both at cargo vessel tiers and on the mega slope, e.g., when cargo containers are pushed against each other. According to some embodiments, mega slope chain conveyor may push and/or pull with notches (see FIG. 3B) which may fit one or more immersed casting points and/or extracting pins on the base and/or sides of a travel tray. According to some embodiments, the mega slope width may be similar to the width of a container cargo bay and may allow a second slope conveyor to function simultaneously at an adjacent bay. Optionally, the first and/or second slope conveyer may include a railing. According to some embodiments, a mega slope conveyor may have higher productivity than a mega crane.

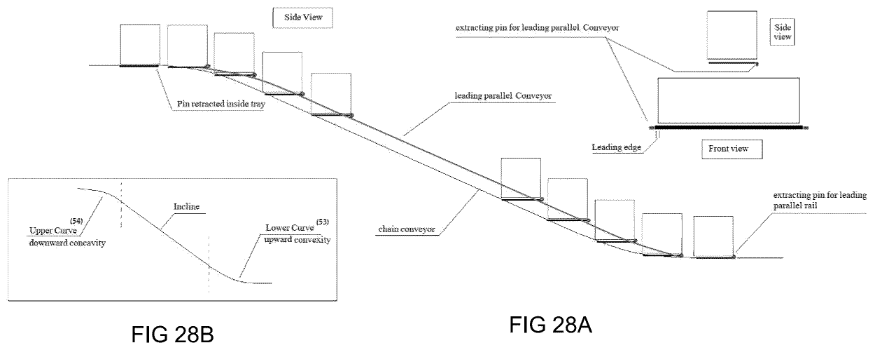

Reference is now made to FIGS. 28A-B, which are schematic diagrams of a side view of a mega slope conveyor, in accordance with some embodiments. According to some embodiments, the mega slope may include adjustable upper and/or lower curves, 54 and/or 53, respectively. According to some embodiments, when the travel tray reaches the mega slope, a side pin may be extended (mechanically and/or electrically). According to some embodiments, the side extracting leading parallel pin may attach to a side of an upper rail of a second conveyor (blue one) According to some embodiments, mathematical function of the slope (Fx) comprised of 3 segments: (from port to vessel) concavity, diagonal incline (slope) and convexity. According to some embodiments, Side upper rail conveyor mathematical function will be like Fx-c, (c as a constant almost equal to the width of a single container) the same function but prior to the function of the mega slope conveyor, which allows the container to be level while conveying the container up the mega slope. According to some embodiments, since the two functions return the same (y) outcome with a constant gap (container width), leveled cargo achieved during incline all 3 segments of the function.

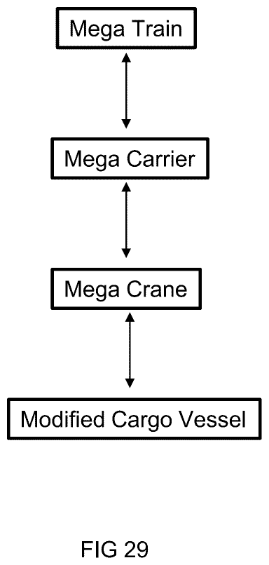

Reference is now made to FIG. 29, which is a flow chart of mega STS systems in accordance with some embodiments of the present invention. For example, the mega STS systems may include a mega train to transport cargo containers to and from a mega carrier. The mega carrier may convey rows of linked containers to a mega crane. The mega crane may transfer rows of linked containers to a cargo vessel.

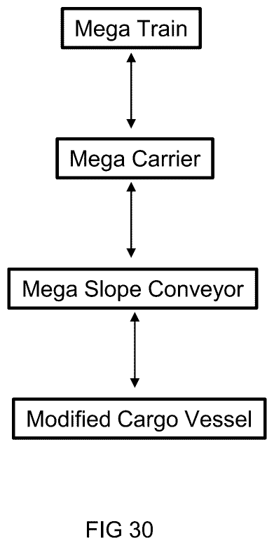

Reference is now made to FIG. 30, which is a flow chart of mega STS systems in accordance with some embodiments of the present invention. For example, the mega STS systems may include a mega train to transport cargo containers to and from a mega carrier. The mega carrier may convey rows of unlinked containers to a mega slope. The mega slope may transfer containers to a cargo vessel.

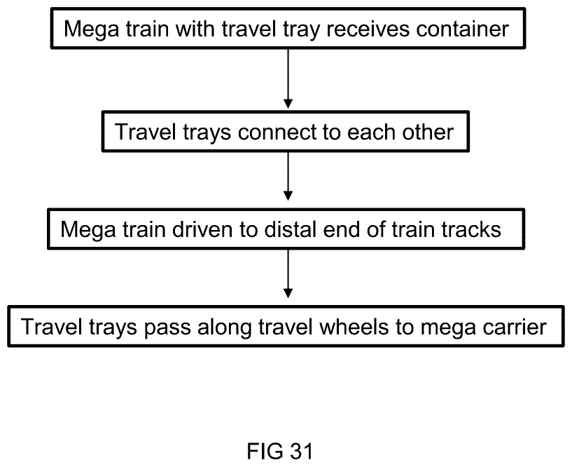

Reference is now made to FIG. 31 which is a flow chart of attachment of a container to a travel tray in accordance with some embodiments. According to some embodiments, a mega train may include one or more travel trays. According to some embodiments, each travel tray may receive a container, e.g., by forklift and/or gantry crane, etc. According to some embodiments, the travel trays may be connected to each other at casting points and/or other connection to provide a row of linked containers. According to some embodiments, the travel train may be driven to the distal end of the tracks for loading a mega carrier. According to some embodiments, the row of linked containers may pass over travel wheels from the mega train onto the mega carrier.

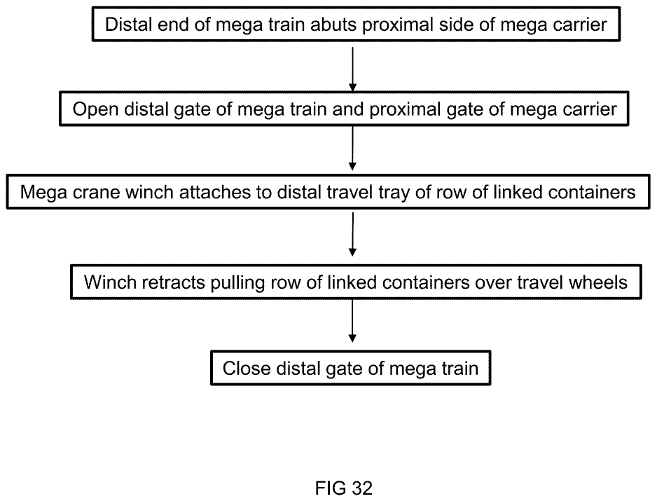

Reference is now made to FIG. 32, which is a flow chart of cargo transfer from mega train to a mega carrier in accordance with some embodiments of the present invention. For example, a mega train may stop next to a mega carrier. The mega carrier may be aligned with a pre-defined position along the railway tracks. The mega carrier may move back and forth between pre-defined positions along the railway tracks for loading and unloading a mega train, mega crane and/or mega slope. Once the distal end of a mega train abuts a proximal side of mega carrier, the distal gate of mega train and proximal gate of mega carrier are opened. A mega carrier winch attaches to distal travel tray of row of linked containers. The winch pulls row of linked containers over travel wheels from mega train onto mega carrier. When the row of linked containers is in place on the mega carrier, the distal gates of mega train and proximal gates of mega carrier are closed.

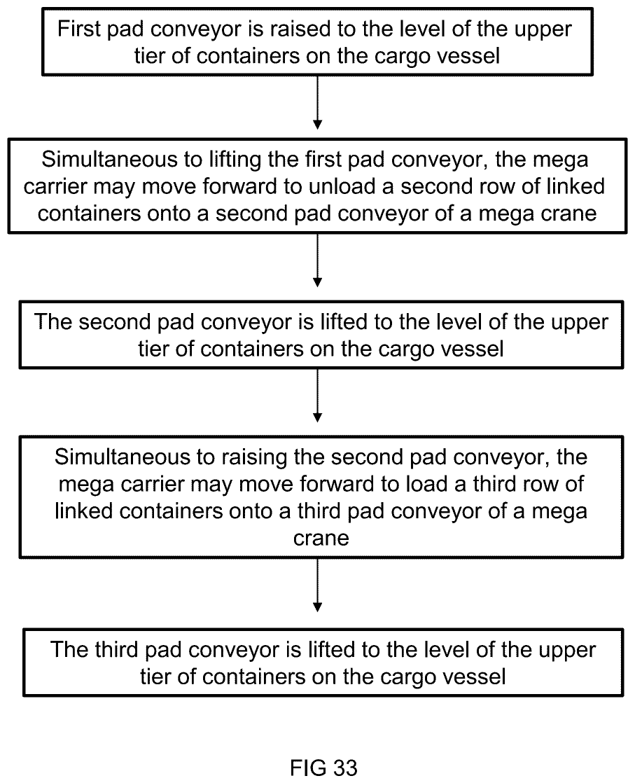

Reference is now made to FIG. 33, which is a flow chart of cargo transfer from mega carrier to a mega crane in accordance with some embodiments of the present invention. For example, a mega carrier may arrive next to a mega crane. The gate at the distal end of the mega carrier and the gate at the proximal side of a pad conveyor of a mega crane are opened. The wheel conveyor moves and/or winch attaches to distal travel tray of a row of linked containers. Winch retracts pulling a row of linked containers over the wheeled conveyor of the mega carrier and the pad conveyor of the mega crane until the end of the mega carrier is reached. The gates of the pad conveyor of the mega carrier are closed. The first pad conveyor is raised to the level of the upper tier of containers on the cargo vessel. Simultaneous to raising the first pad conveyor, the mega carrier may move forward such that a second row of linked containers is similarly transferred from a mega carrier onto a second pad conveyor of a mega crane. The second pad conveyor is raised to the level of the destination tier of containers on the cargo vessel. Simultaneous to raising of the second pad conveyor, the mega train may move forward such that a third row of linked containers is similarly transferred from a mega carrier onto a third pad conveyor of a mega crane. The third pad conveyor is raised to the level of the destination tier of containers on the cargo vessel.

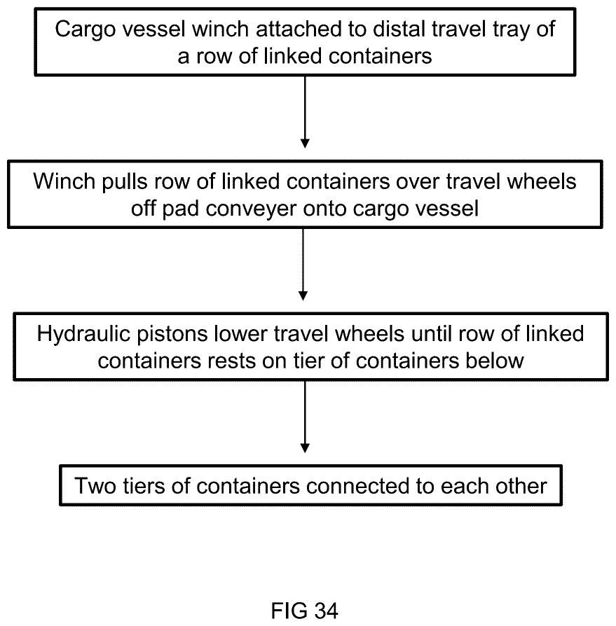

Reference is now made to FIG. 34, which is a flow chart of cargo transfer to a cargo vessel in accordance with some embodiments of the present invention. For example, a winch from a cargo vessel may attach to the distal travel tray of a row of linked containers. The winch may pull the row of linked containers off a pad conveyor of a mega crane over the travel wheels of the travel pillars of the cargo vessel. Once the containers have reached their required position in the cargo vessel bay, they are stopped, Hydraulic pistons attached to the travel wheels are lowered, lowering the containers onto the tops of the containers of the tier below them. The two tiers of containers are then connected to each other by one or more automatic twist locks.

Furthermore, horizontal connections may be made between travel tray of previous loaded containers to the new row of containers lowered thereon. Optionally, both vertical and horizontal connections may be made, e.g., at casting points and male and female connection points.

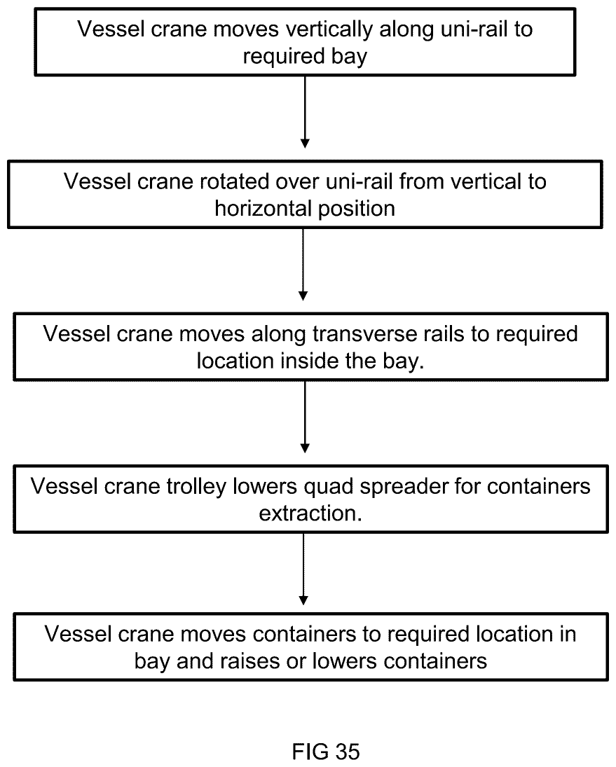

Reference is now made to FIG. 35, which is a flow chart of cargo transfer to a vessel crane, in accordance with some embodiments of the present invention. According to some embodiments, a vessel crane may move along a required bay is reached, it may travel along one or more transverse rails. The vessel crane may then move along the bay to the required position and may lower a quad spreader which may be attached to the casting points on the top part of one or more containers. The containers may then be transported to the required location, where the trolley may be locked in place and the containers raised and/or lowered e.g., to below deck storage. According to some embodiments, the vessel crane may move on flipping longitudinal rails.

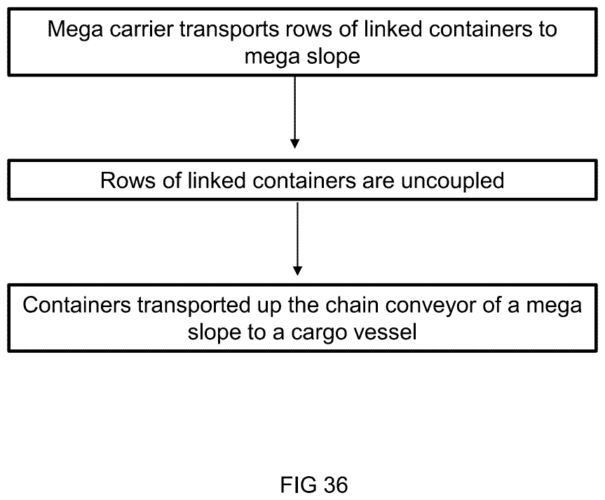

Reference is now made to FIG. 36, which is a flow chart of cargo transfer using a mega slope, in accordance with some embodiments of the present invention. According to some embodiments, a mega carrier may transport rows of linked containers to a mega slope. The rows of linked containers may be disconnected, and then each container may be transported up a chain conveyor of a mega slope to a cargo vessel.

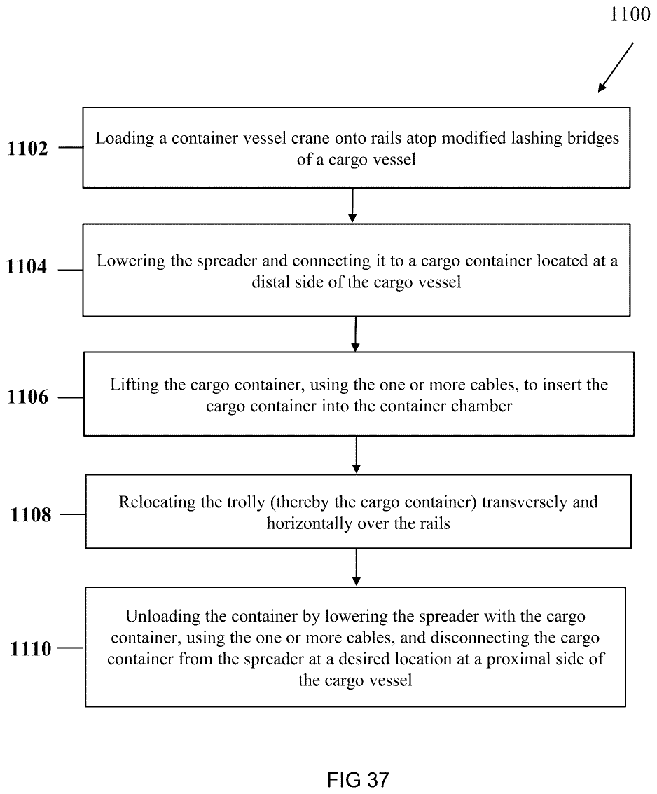

Reference is now made to FIG. 37, which is a flow chart of a method for relocating a cargo container on a cargo vessel from distal side of the cargo vessel to proximal side of cargo vessel or vice versa, using a container vessel crane, such as but not limited to, container vessel crane 100 (FIGS. 21F-21G) and modified lashing bridges, such as but not limited to, lashing bridges 304 (FIG. 21H). It is noted that, the distal side of the cargo vessel is the side of the vessel farthest from the terminal and the proximal side of the cargo vessel is the side of the vessel closest to the terminal and containers.

At step 1102, a container vessel crane is loaded onto rails atop modified lashing bridges of a cargo vessel.

At step 1104, the spreader is lowered (vertically) and connected to a cargo container located at a distal side of the cargo vessel.

At step 1106, the cargo container is lifted using the one or more cables and the cargo container is inserted into the container chamber.

At step 1108, the trolly (thereby the cargo container) transversely and horizontally relocated over the rails.

At step 1110, the container is unloaded by lowering the spreader with the cargo container, using the one or more cables, and disconnecting the cargo container from the spreader at a desired location at a proximal side of the cargo vessel.

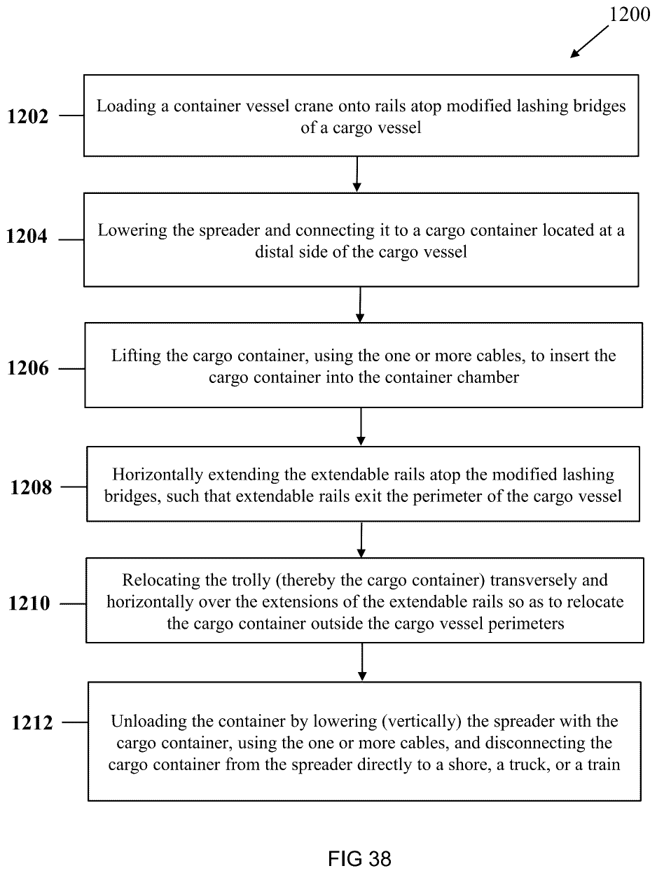

Reference is now made to FIG. 38, which is a flow chart of a method for relocating a cargo container on a cargo vessel from distal side of the cargo vessel directly to a shore, a truck, or a train or vice versa, using a container vessel crane, such as but not limited to, container vessel crane 100 (FIGS. 21F-21G) and modified lashing bridges, such as but not limited to, lashing bridges 304 (FIG. 21H).

At step 1202, a container vessel crane is loaded onto rails atop modified lashing bridges of a cargo vessel.

At step 1204, the spreader is lowered (vertically) and connected to a cargo container located at a distal side of the cargo vessel.

At step 1206, the cargo container is lifted using the one or more cables and the cargo container is inserted into the container chamber.

At step 1208, the extendable rails atop the modified lashing bridges are horizontally extended, such that the extendable rails exit the perimeter of the cargo vessel.

At step 1210, the trolly (thereby the cargo container) transversely and horizontally relocated over the extensions of the extendable rail, and the cargo container is relocated outside the cargo vessel perimeters.

At step 1212, the container is unloaded by lowering the spreader with the cargo container, using the one or more cables, and disconnecting the cargo container from the spreader directly to a shore, a truck, or a train.

According to some embodiments, the cargo container relocations described in FIG. 37 and in FIG. 38, may be simultaneously operated by multiple (preferably two) container vessel cranes each on a separate bay to assist each ship to shore (STS) cranes. According to some embodiments, each container vessel crane relocates cargo containers from distal side (or row) of the cargo vessel to proximal side (or row) of cargo vessel, thereby assisting in reducing the STS crane's route.

According to some embodiments, the cargo container relocations described in FIG. 37 and in FIG. 38, may further include mounting modified lashing bridges atop on-board lashing bridges (at the sides of a bay) of a cargo vessel.

It should be understood that while the invention is described for loading cargo containers onto a cargo vessel from a port, the reverse procedure (to unload cargo container from a cargo vessel to a port) may carried out using the mega STS systems and methods, and/or parts thereof disclosed herein.

### EXAMPLES

TABLE 1
Chart of steps and capacity.

| | | | Time | | | | | | | | | | | |
|---|---|---|---|---|---|---|---|---|---|---|---|---|---|---|
| | | | Speed | | Speed | | Speed | | | | | | | |
| | Distance | | 2.4 Km/h | | 3.6 Km/h | | 4.8 Km/h | | | | | | | |
| | (A) | | (B) | | (C) | | (C) | | Description | | | | | |
| 1 | 20 | m | 30 | s | 20 | s | 15 | s | Pad | | | | | |
| | | | | | | | | | Conveyor | | | | | |
| | | | | | | | | | 1 receives | | | | | |
| | | | | | | | | | 1^{st} row of | | | | | |
| | | | | | | | | | containers | | | | | |
| 2 | 20 | m | 30 | s | 20 | s | 15 | s | Crane | Pad | | | | |
| | | | | | | | | | lifts Pad | Conveyor | | | | |
| | | | | | | | | | Conveyor | 2 receives | | | | |
| | | | | | | | | | 1 to | 2^{nd} rows | | | | |
| | | | | | | | | | middle | of | | | | |
| | | | | | | | | | height | containers | | | | |
| 3 | 20 | m | 30 | s | 20 | s | 15 | s | Pad | Crane | Pad | | | |
| | | | | | | | | | Conveyor | lifts Pad | converter | | | |
| | | | | | | | | | 1 arrives | Conveyor | 3 receives | | | |
| | | | | | | | | | at top tier | 2 to | 3^{rd} row of | | | |
| | | | | | | | | | unloading | middle | containers | | | |
| | | | | | | | | | point | height | | | | |
| 4 | 20 | m | 30 | s | 20 | s | 15 | s | Pad | Pad | Crane | Cargo | mega | |
| | | | | | | | | | conveyor | Conveyor | lifts Pad | vessel | Carrier | |
| | | | | | | | | | 1 unloads | 2 arrives | Conveyor | receives | returns to | |
| | | | | | | | | | 1^{st} row | at top tier | 3 to | 1^{st} row | mega | |
| | | | | | | | | | | unloading | middle | onboard | Train | |
| | | | | | | | | | | point | height | | | |
| 5 | 20 | m | 30 | s | 20 | s | 15 | s | Pad | Pac | Pad | 1^{st} row of | Cargo | |
| | | | | | | | | | conveyor | conveyor | Conveyor | containers | vessel | |
| | | | | | | | | | 1 goes up | 2 unloads | 3 arrives | reaches | receives | |
| | | | | | | | | | to waiting | the 2^{nd} | at top tier | destination | 2^{nd} row | |
| | | | | | | | | | position | row | unloading | | onboard | |
| | | | | | | | | | | | point | | | |
| 6 | 20 | m | 30 | s | 20 | s | 15 | s | Hydraulic | Pad | Pad | | 2^{nd} row of | Cargo |
| | | | | | | | | | pistons | conveyor | conveyor | | containers | vessel |
| | | | | | | | | | lower 1^{st} | 2 goes up | 3 unloads | | reaches | receives |
| | | | | | | | | | row on | to waiting | the 3^{rd} | | end point | 3^{rd} row |
| | | | | | | | | | the tier | position | row | | | onboard |
| | | | | | | | | | beneath | | | | | |
| 7 | 20 | m | 30 | s | 20 | s | 15 | s | | Hydraulic | Pad | | | 3^{rd} row of |

| | | | | | | | pistons | conveyors | containers |
|---|---|---|---|---|---|---|---|---|---|
| | | | | | | | lower 2^{nd} | 1 + 2 + 3 go | reaches |
| | | | | | | | row on | down to | end point |
| | | | | | | | the tier | collect | |
| | | | | | | | beneath | next load | |
| 8 | 4 | s | 4 | s | 4 | s | | Hydraulic | |

| | | | | | | | pistons |
|---|---|---|---|---|---|---|---|
| | | | | | | | lower the |
| | | | | | | | 3^{rd} row on |
| | | | | | | | the tier |
| | | | | | | | beneath |
| Adjustment | 120 | s | 120 | s | 120 | s | |
| time (D) | | | | | | | |
| Total Time | 334 | s | 264 | s | 229 | s | |

| | | | |
|---|---|---|---|
| Containers/hour | 258 | 327 | 377 |
| per mega crane | | | |

(A) Distance to pull 8 containers × ~2.5 m width = ~20 m.
(B) Speed of 2.4 km/h is Max Speed of Industrial wheel Conveyor.
(C) Speed of 3.6 km/h or 4.8 km/h achieved by power winch.
(D) Time spent for adjustment and/or correction at each stage average of 15 s × 8 stages = 120 s

For example:

A standard STS crane can load up to 50 containers/hour.

At a speed of 2.4 km/h a mega crane can load up to 258 containers/hour.

At a speed of 3.6 km/h a mega crane can load up to 327 containers/hour.

At a speed of 4.8 km/h a mega crane can load up to 377 containers/hour.

According to some embodiments the terms “normal” or “normally” refer to behavior (e.g., movement) of parts (reference points) in a fully functional, intact system.

According to some embodiments, the terms “expand” and “extend”, and “expansion” and “extension” are used interchangeably.

In the description and claims of the application, the words “include” and “have”, and forms thereof, are not limited to members in a list with which the words may be associated.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

What is claimed is:

1. A container vessel crane for horizontal and vertical relocation of cargo containers on a cargo vessel, the container vessel crane comprising:
a trolly comprising:
a container chamber configured to accommodate a container to be relocated, the container chamber comprises at least a bottom opening configured to insert the container into the container chamber;
a spreader and head block chamber, mounted on top of the container chamber; and
a machine room mounted on the spreader and head block chamber;
a spreader positioned within the spreader and head block chamber and configured to connect/disconnect to/from the container;
a headblock comprising one or more pulleys and one or more cables, the headblock is positioned on top of the spreader and within the spreader and head block chamber;
four or more container casting connections atop the machine room configured to facilitate connection by the spreader of the ship-to-shore (STS) crane;
one or more cable drums positioned within the machine room configured to rotate thus to roll or unroll the one or more cables thereby allowing vertical movement (up and down) of the container; and
one or more engines coupled to the one or more cable drums.

2. The container vessel crane according to claim 1, wherein the trolly further comprising a set of side wheels connected to bottom side bases of the trolly and configured to facilitate transvers and horizontal movement of the trolly on board of the cargo vessel.

3. The container vessel crane according to any one of claims 1-2, wherein the one or more engines comprises gears.

4. The container vessel crane according to any one of claims 1-3, configured for movement over modified lashing bridges equipped with rails positioned atop them, wherein the modified lashing bridges are heightened above a highest (upper) tier of cargo containers.

5. The container vessel crane according to any one of claims 2-4, wherein the side wheels have a V-shaped cross-section to allow centralized movement of the side wheels within the rails.

6. The container vessel crane according to any one of claims 4-5, wherein the rails have a V-shaped cross-section with a negative shape configured to compatibly accommodate the set of side wheels.

7. The container vessel crane according to any one of claims 2-6, wherein the side wheels are contractable when passing through the STS legs and extractable after passing STS legs and before mounting on top of the rails, thus allowing easer pass of the container vessel crane between the legs of the STS crane, thereby facilitating shorter trolley's structure (about 45 feet) of the container vessel crane.

8. The container vessel crane according to any one of claims 1-7, configured to facilitate extracting/relocating cargo containers located at lower tiers aboard of the cargo vessel and/or at the lower tiers within the underdeck of the cargo vessel.

9. The container vessel crane according to any one of claims 1-8, further comprising a controller unit for manual/autonomous operation or wireless communication with a user.

10. The container vessel crane according to any one of claims 1-9, wherein the container chamber is configured to secure the cargo container.

11. The container vessel crane according to any one of claims 1-10, wherein the container chamber is configured to position the cargo container at a lifted position so as to move over upper tier (of on-board cargo containers).

12. The container vessel crane according to any one of claims 2-11, wherein the set of side wheels is powered by two sided separate sets of engines and gears to facilitate reliable operation.

13. The container vessel crane according to any one of claims 1-12, wherein the one or more engines are electric, hydraulic, pneumatic engines, or a combination thereof.

14. The container vessel crane according to any one of claims 1-13, wherein the container chamber and the spreader and head block chamber are joint as one chamber.

15. The container vessel crane according to any one of claims 1-14, mountable on the cargo vessel while moored (docked) at a terminal and/or while at sea (during a voyage).

16. The container vessel crane according to any one of claims 1-15, wherein the container chamber is configured to accommodate one or more cargo containers.

17. The container vessel crane, according to any one of claims 4-16, wherein the rails of the modified lashing bridges comprise horizontally extendable beams with rails on their top allowing the container vessel crane to exit the cargo vessel perimeters thereby enabling unloading and/or loading containers directly to/from a shore, a truck, or a train.

18. The container vessel crane of claim 17, further comprising extendable diagonal reinforcements configured to support the rails when horizontally extended.

19. A modified lashing bridge for facilitating a container vessel crane movement thereatop, the modified lashing bridge comprises:
a rail positioned atop the lashing bridge; and
a stopper (bumper) mounted at the end of the rail and configured to limit the container vessel crane's movement beyond the rail,
wherein the modified lashing bridge is configured to be installed on top of the existing lashing bridge of a cargo vessel thereby heightening the lashing bridge above the highest tier of cargo containers,
wherein the lashing bridges comprising a fixed diagonal reinforcement at a base thereof configured to enhance strength and longitudinal tilt resistance of the modified lashing bridges.

20. The modified lashing bridges according to claim 19, further comprising horizontally extendable beams with rails on top thereof allowing the container vessel crane to exit the cargo vessel perimeters thereby enabling unloading (or loading) containers to (or from) a shore, a truck, or a train.

21. The modified lashing bridges according to any one of claims 19-20, further comprising extendable diagonal ratchet telescopic hydraulic reinforcements configured to support the extended rails when horizontally extended.

22. A system for horizontal and vertical relocation of cargo container on a cargo vessel, the system comprising:
a container vessel crane, the container vessel crane comprising:
a trolly comprising:
a container chamber configured to accommodate a container to be relocated;
spreader and head block chamber, mounted on top of the container chamber; and
machine room mounted on the spreader and head block chamber; and
a spreader positioned within the spreader and head block chamber and configured to connect/disconnect to/from the container, and
a headblock comprising one or more pulleys and one or more cables, the headblock is positioned on top of the spreader and within the spreader and head block chamber;
one or more cable drums positioned within the machine room configured to rotate thus to roll or unroll the one or more cables thereby allowing vertical movement (up and down) of the container; and
one or more engines coupled to the one or more cable drums; and
at least two modified lashing bridges for facilitating the container vessel crane transverse and horizontal movement thereatop, the modified lashing bridge comprises:
a rail positioned atop each of the at least two lashing bridges; and
a stopper (bumper) mounted at the end of each of the rails and configured to limit the container vessel crane's movement beyond the rails,
wherein the at least two modified lashing bridges are configured to be installed on top of the existing lashing bridges of the cargo vessel thereby heightening the lashing bridges above the highest tier of cargo containers.

23. A method for relocating a cargo container on a cargo vessel from distal side of the cargo vessel to proximal side of cargo vessel or vice versa, using a container vessel crane and modified lashing bridges, wherein the distal side of the cargo vessel is the side of the vessel farthest from the terminal and the proximal side of the cargo vessel is the side of the vessel closest to the terminal and containers, the method comprising:
loading a container vessel crane onto rails atop modified lashing bridges of a cargo vessel, the container vessel crane comprising:
a trolly comprising a container chamber;
a spreader connectable to a cargo container;
a headblock comprising: one or more pulleys and one or more cables;
one or more cable drums; and
one or more engines coupled to the one or more cable drums,
lowering the spreader and connecting it to a cargo container located at a distal side of the cargo vessel;
lifting the cargo container, using the one or more cables, to insert the cargo container into the container chamber;
relocating the trolly (thereby the cargo container) transversely and horizontally over the rails; and
unloading the container by lowering the spreader with the cargo container, using the one or more cables, and disconnecting the cargo container from the spreader at a desired location at a proximal side of the cargo vessel.

24. A method for relocating a cargo container on a cargo vessel from distal side of the cargo vessel directly to a shore, a truck, or a train or vice versa, using a container vessel crane and modified lashing bridges, wherein the distal side of the cargo vessel is the side of the vessel farthest from the terminal and the proximal side of the cargo vessel is the side of the vessel closest to the terminal and containers, the method comprising:
loading a container vessel crane onto extendable beams with rails atop modified lashing bridges of a cargo vessel, the container vessel crane comprising:
a trolly comprising a container chamber;
a spreader connectable to a cargo container;
a headblock comprising: one or more pulleys and one or more cables;
one or more cable drums; and
one or more engines coupled to the one or more cable drums,
lowering the spreader and connecting it to a cargo container located at a distal side of the cargo vessel;
lifting the cargo container, using the one or more cables, to insert the cargo container into the container chamber;
horizontally extending the extendable beams with rails atop the modified lashing bridges, such that extendable beams with rails exit the perimeter of the cargo vessel;
relocating the trolly (thereby the cargo container) transversely and horizontally over the extensions of the extendable beams with rails so as to relocate the cargo container outside the cargo vessel perimeters; and
unloading the container by lowering (vertically) the spreader with the cargo container, using the one or more cables, and disconnecting the cargo container from the spreader to a shore, a truck, or a train.

25. The method according to any one of claims 23-24, further comprising simultaneously operating multiple (preferably two) container vessel cranes each on a separate bay to assist each ship to shore (STS) cranes by relocating cargo containers close to the terminal thus reducing the ship to shore crane route and by relocating cargo containers from distal rows with respect to the terminal to proximal rows with respect to the terminal.

26. The method according to any one of claims 23-25, further comprising mounting modified lashing bridges atop on-board lashing bridges (at the sides of a bay) of a cargo vessel, the modified lashing bridges comprising: a rail positioned atop the lashing bridge, and a stopper (bumper) mounted at the end of the rail.

27. Use of the container vessel crane according to any one of claims 1-18, for relocating cargo container at the terminal's yard on designated rails on ground.
